(19) United States
(12) Patent Application Publication
(10) Pub. No.: US 2020/0410001 A1
(43) Pub. Date: Dec. 31, 2020

(54) NETWORKED COMPUTER-SYSTEM MANAGEMENT AND CONTROL

(71) Applicant: Apomatix Inc., Wilmington, DE (US)

(72) Inventor: Vartan Sarkissian, Auckland (NZ)

(21) Appl. No.: 16/976,238

(22) PCT Filed: Mar. 21, 2019
(86) PCT No.: PCT/US2019/023394

§ 371 Date: Aug. 27, 2020

Related U.S. Application Data
(60) Provisional application No. 62/646,576, filed on Mar. 22, 2018.

(51) Int. Cl. G06F 16/903; G06N 20/00; H04L 29/08; G06F 3/0482

(52) U.S. Cl. CPC G06F 16/903; G06N 20/00; G06F 3/0482; H04L 67/26; H04L 67/306

(57) ABSTRACT

A system includes an event-source device; a state database holding first state data; a controllable computing device; and a monitoring device. The monitoring device receives an event record from the event-source device; determines, based at least in part on the first state data and the event record, a command; and transmits the command to the controllable computing device or otherwise causes the controllable computing device to carry out (e.g., perform an action associated with) the command. Some examples include determining a computational model based at least in part on first state data associated with a first data source. The computational model is operated based at least in part on an event record associated with a second data source to provide a command. A representation of the command is presented, via a user interface. A computing device can be caused to carry out the command.

### CROSS-REFERENCE TO RELATED APPLICATIONS

This international application claims priority to, and the benefit of, U.S. patent application Ser. No. 62/646,576, filed Mar. 22, 2018, under Atty. Docket No. A168-0002USP1, and entitled “COMPUTERIZED RISK MANAGEMENT,” the entirety of which is incorporated herein by reference.

### BACKGROUND

Many organizations use networks of computing devices. The demands placed on these devices and networks may vary over time. However, determining and applying changes in response to such variations can be complex and error-prone.

### BRIEF DESCRIPTION OF THE DRAWINGS

Objects, features, and advantages of various aspects will become more apparent when taken in conjunction with the following description and drawings. Identical reference numerals have been used, where possible, to designate identical features that are common to the figures. The attached drawings are for purposes of illustration and are not necessarily to scale. For brevity of illustration, in the diagrams herein, an arrow beginning with a diamond connects a first component or operation (at the diamond end) to at least one second component or operation that is or can be included in the first component or operation.

FIGS. 1A and 1B show a dataflow diagram of systems and techniques according to various examples.

FIG. 2 shows example data types and values that can be stored or processed according to various examples.

FIG. 3 shows an example event-processing technique according to various examples.

FIG. 4 shows an example machine-learning and data-analytics architecture according to various examples.

FIG. 5 shows operations for performing machine learning and data analytics according to various examples.

FIG. 6 shows modules of an event-processing system according to various examples.

FIG. 7 is a high-level diagram showing the components of a data-processing system according to various examples.

FIG. 8 shows an example system for monitoring or controlling a computing device via a network, and related data items.

FIG. 9 shows a dataflow diagram illustrating an example process for controlling a computing device via a network, and related data items.

FIG. 10 shows a dataflow diagram illustrating an example process performed by a monitoring device for controlling a computing device via a network, and related data items.

FIG. 11 shows a dataflow diagram illustrating an example process performed by a monitoring device for controlling a computing device via a network, and related data items.

FIG. 12 shows a dataflow diagram illustrating an example process for controlling a computing device and related data items.

FIG. 13 shows a dataflow diagram illustrating an example process for controlling a computing device and related data items.

FIG. 14 shows a dataflow diagram illustrating an example process for controlling a computing device and related data items.

FIG. 15 shows a dataflow diagram illustrating an example process for controlling a computing device and related data items.

FIG. 16 shows a dataflow diagram illustrating an example method for controlling a computing device and related data items.

FIG. 17 shows a dataflow diagram illustrating an example method for controlling a computing device and related data items.

FIG. 18 shows a dataflow diagram illustrating an example method for controlling a computing device and related data items.

FIG. 19 shows a dataflow diagram illustrating an example method for controlling a computing device and related data items.

FIG. 20 shows a dataflow diagram illustrating an example method for controlling a computing device and related data items.

FIG. 21 shows a dataflow diagram illustrating an example method for controlling a computing device and related data items.

FIG. 22 shows a dataflow diagram illustrating an example method for controlling a computing device and related data items.

FIG. 23 shows a dataflow diagram illustrating an example method for controlling a computing device and related data items.

FIG. 24 shows a dataflow diagram illustrating an example method for controlling a computing device and related data items.

### DETAILED DESCRIPTION

### Overview

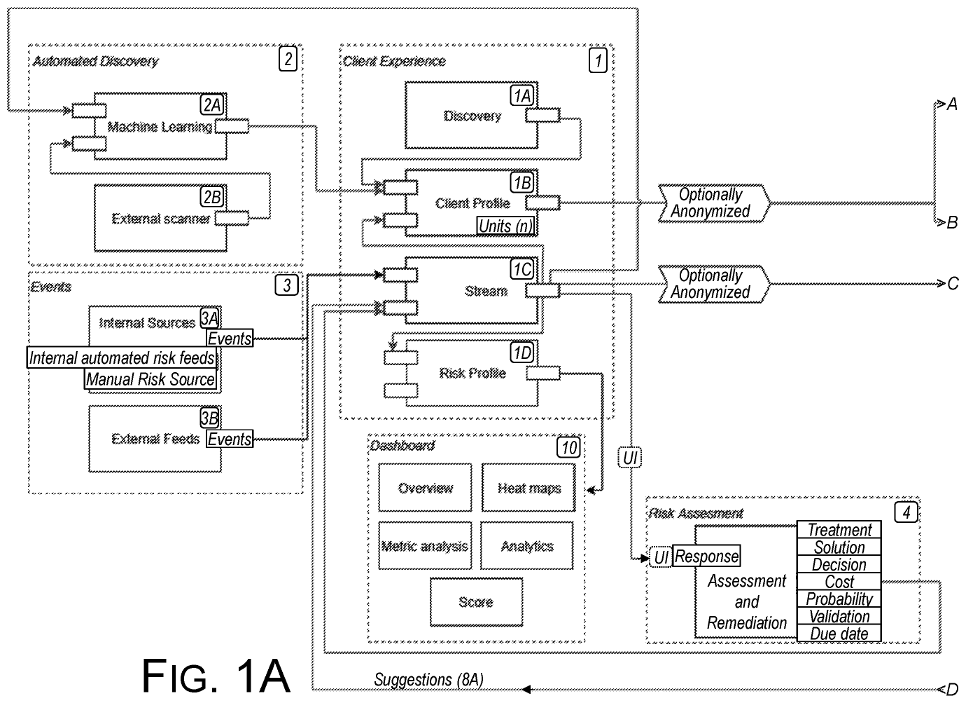

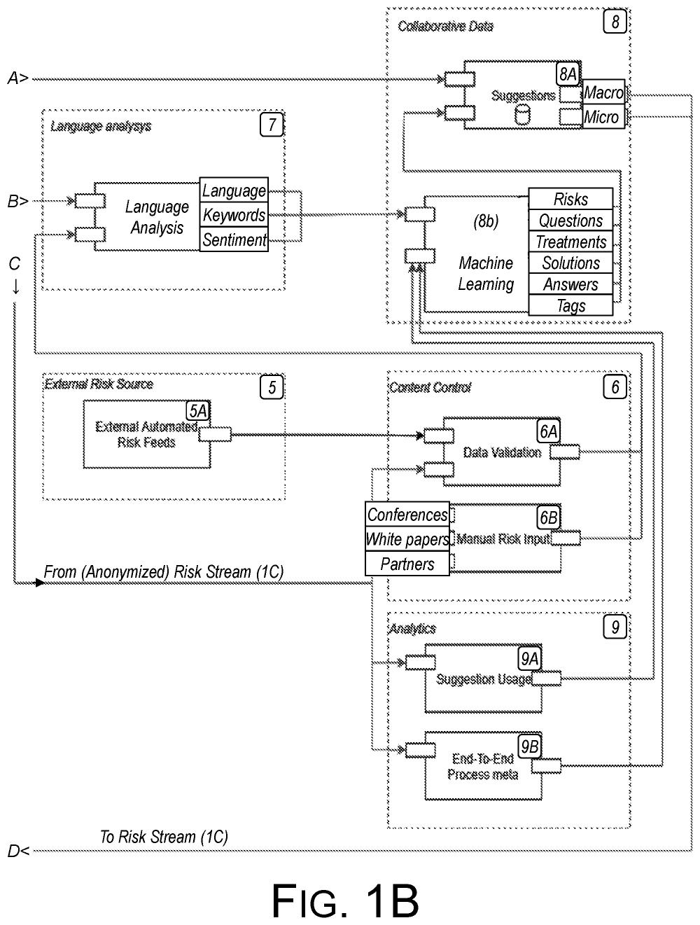

Various examples include receiving event records, determining commands at least partly in response, and causing controllable computing devices to perform those commands. The commands can include, e.g., configuration commands or notification commands. Various examples permit more effectively updating device or network configurations, forwarding event information for processing, or integrating multiple sources of event information in order to determine commands. Various examples include training or use of computational models (CMs) to perform functions described herein, e.g., to determine commands. Throughout this document, references such as “(1a)” refer to the corresponding blocks in FIGS. 1A-1B.

Example embodiments described or shown herein are provided for purposes of example only. Statements made herein with respect to a particular example embodiment, or a specific aspect of that example embodiment, should not be construed as limiting other example embodiments described herein. Features described with regard to one type of example embodiment may be applicable to other types of example embodiments as well. The features discussed herein are not limited to the specific usage scenarios with respect to which they are discussed.

Throughout this description, some aspects are described in terms that would ordinarily be implemented as software programs. Those skilled in the art will readily recognize that the equivalent of such software can also be constructed in hardware, firmware, or micro-code. The present description is directed in particular to algorithms and systems forming part of, or cooperating more directly with, systems and methods described herein. Aspects not specifically shown or described herein of such algorithms and systems, and hardware or software for producing and otherwise processing signals or data involved therewith, can be selected from systems, algorithms, components, and elements known in the art.

In view of the discussion herein, various aspects permit diagnosing risks, including risks that are any, or any combination, of: technical or non-technical, local or network-mediated, or internal or external to an organization. External risks can include, e.g., risks introduced by suppliers/vendors. Various examples include software configured to perform at least one of the following: identify risks associated with a supplier, identify treatments/solutions for risks relevant to that specific supplier, prioritize risks, set remediation dates, manage tasks during remediation, provide remediation updates, track remediations until completion, or re-score and re-evaluate treatments/solutions versus risk once remediations are complete. Various examples use machine learning and data analytics to guide, suggest, track, automate risk-management strategies, and determine possible treatments/solutions for a risk in the context of Meta-Data such as that discussed below (such as location, turnover, industry, or number of employees).

The term “pre-emptive” (and similar terms), as used herein, marks some examples that can provide management of risks that have not yet negatively affected a party (although neither those, nor any other examples herein, are limited to those risks; various examples can manage mitigation of risks that have already had a negative effect).

Various examples here in are referred to as “Gen” 1, 2, or 3. These terms refer to sets of example features. The application is not limited to each set individually. In some examples, at least one “Gen 1” feature and at least one “Gen 2” feature are combined. In some examples, all of the “Gen 1” features are used together with at least one “Gen 2” feature. For example, “Gen 1” user-interface (UI) components or techniques can be used with “Gen 2” machine-learning or database techniques.

Various aspects include, or are embodied at least partly in, at least one of a cloud-based SaaS platform such as a computing cluster (examples discussed below), an on-premises computing appliance, or a desktop or mobile application. The desktop or mobile application can serve as a front-end user interface for a cluster or appliance, or can include functions described herein within the desktop computer or mobile device itself.

In some examples, a “risk” describes a threat that may exploit a vulnerability and thereby cause loss, damage, or destruction of an asset. Risks can include, but are not limited to, internal or external cyber risks, threats and vulnerabilities, or other risks, e.g., technical, non-technical, internal, direct external, or indirect external risks. Non-technical risks can include audit, compliance, diligence, environmental, financial, governance, legal, merger, operational, regulatory, statutory, quality-assurance, or policy-based risks, or risks posed by a lack of compliance procedures, governance procedures, or policies. These non-technical risks can, in some examples, lead to technical risks such as cyber risks. For example, risks in defining the organization's chain of command can increase uncertainty about which personnel are responsible for applying updates to computing systems, which can increase the risk of a cyberattack against those systems. In some example, “internal risks” relate to factors under a client's control; direct external risks relate to factors outside the immediate client environment but still under reasonable control, e.g., supply chain/vendors; and “indirect external” risks relate to factors that are outside the client's environment, also not under direct control of the client but have an effect on the client's environment (e.g., new viruses, threats, or vulnerabilities). These categories are for clarity of discussion and are not limiting.

Various examples herein use crowdsourced data and machine learning to determine appropriate commands or other responses to present or predicted events, e.g., events associated with risks. Various examples use time, location, or other factors in determining commands. Various examples receive as input data/metadata collected from a system's operating environment to respond to the activities of an organization in real time or near real-time.

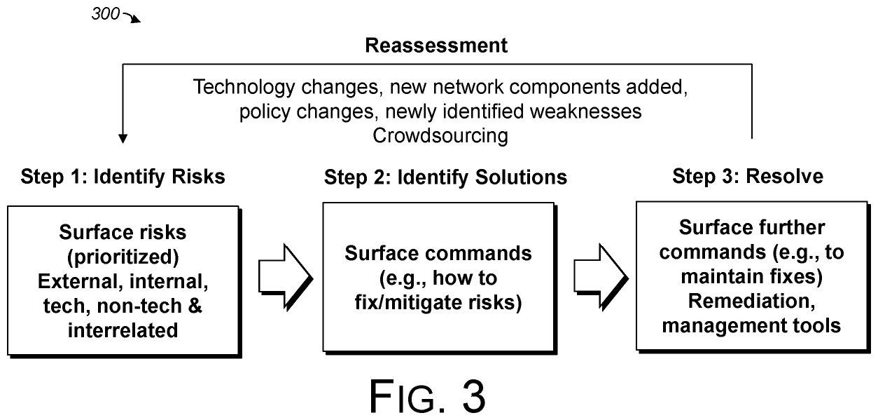

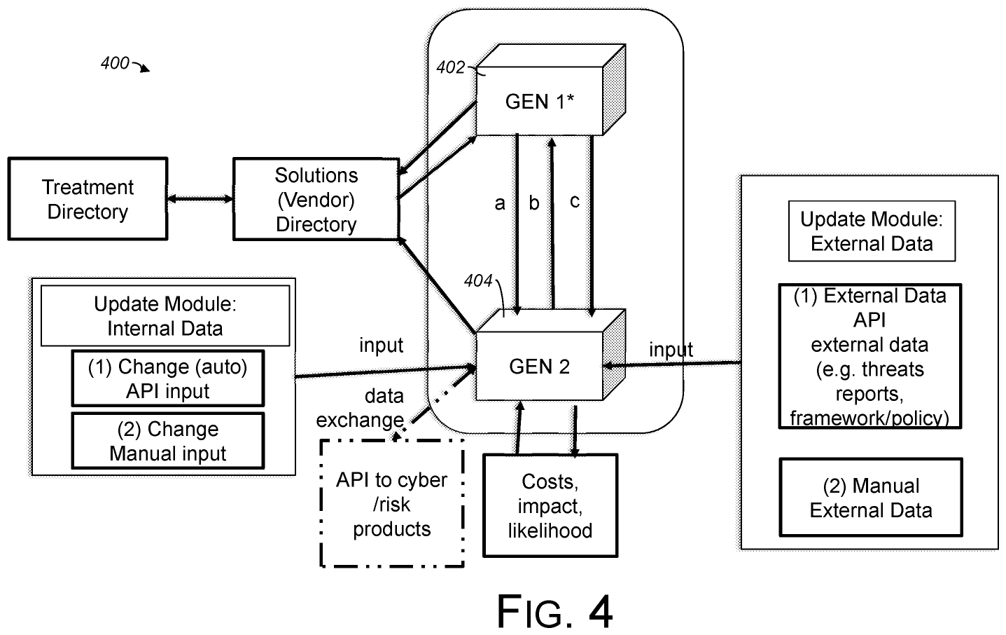

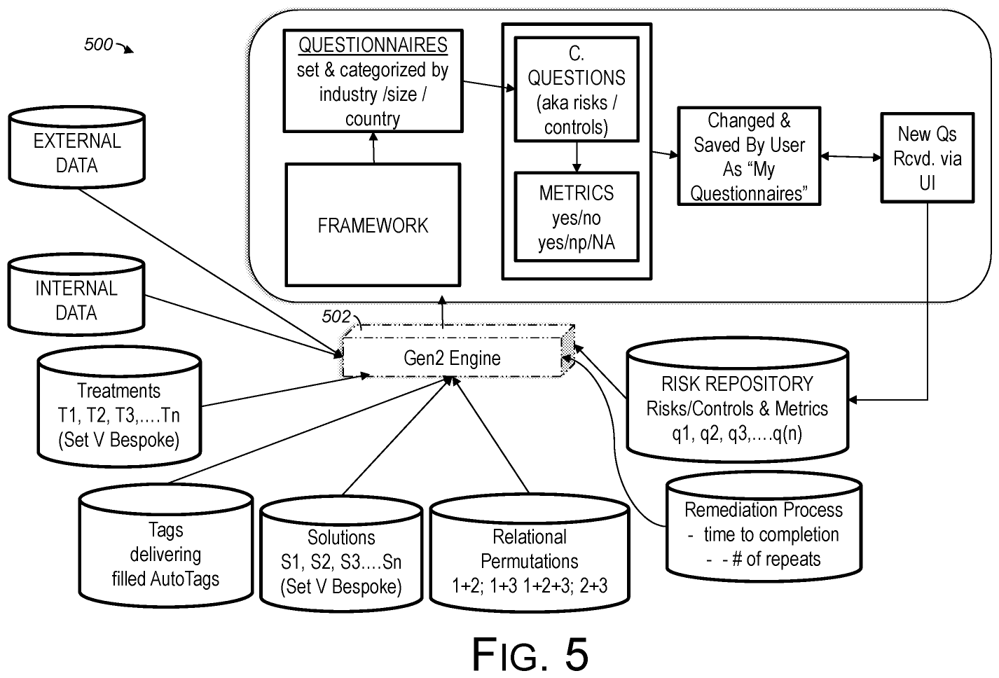

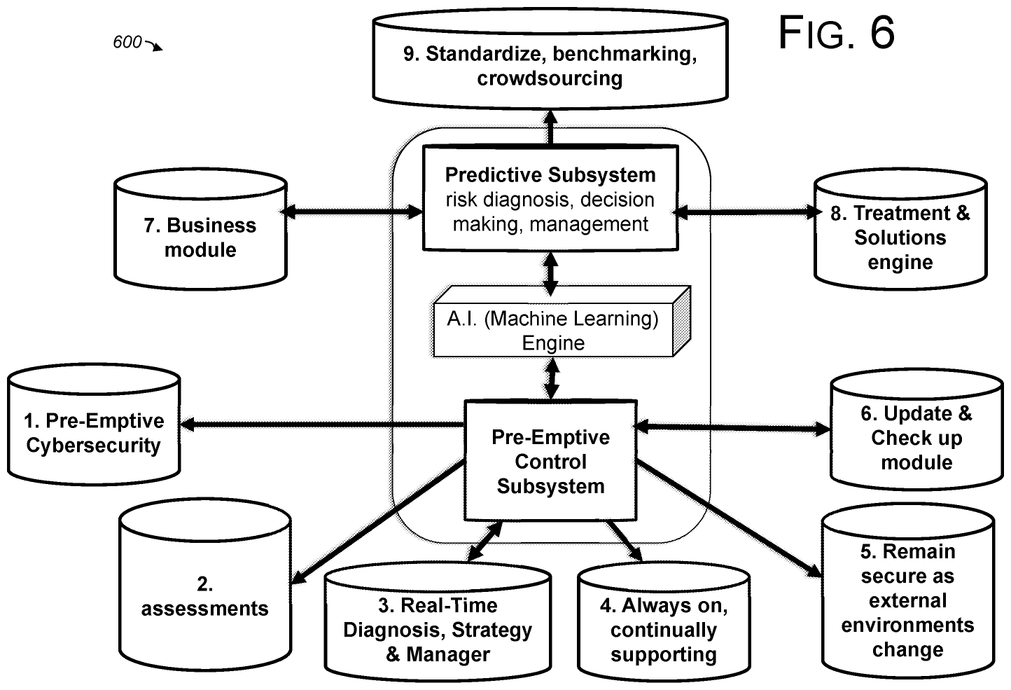

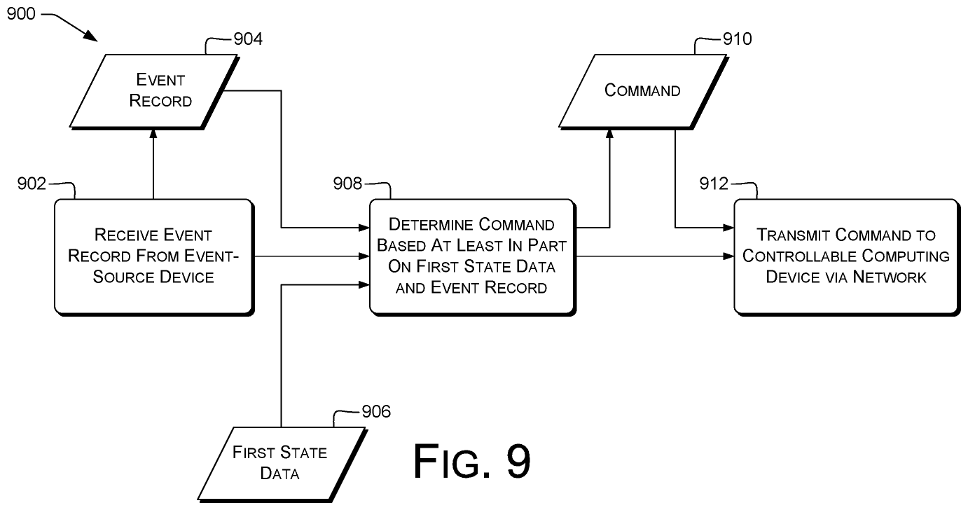

Various examples include at least one of the following items, in any of which software can be delivered as a service (SaaS) (e.g., cloud-based) or via other deployment techniques (e.g., local installation): 1. Cloud based software to detect and mitigate risks (e.g., implementing FIG. 1A-1B, 3-6, or 9-24, or running on systems of FIG. 7 or 8); 2. Such software configured to identify resolutions to risks and to prioritize responses to such risks (e.g., FIG. 1A; FIG. 3 Step 2; FIG. 4; FIG. 5 Treatments, Solutions, Remediation Process; FIG. 6 #1, 3, 5); 3. such software configured to generate risk remediation timelines that manage risk remediation and track and reanalyze the identified risks once managed (e.g., FIG. 1 (4); FIG. 3 Step 3; FIG. 5; FIG. 6 #6, #8; FIG. 11); 4. Such software configured to perform machine learning training or to use trained models for any or all of: risk identification, risk diagnosis, decision making, management, pre-emptive risk planning and mitigation, or risk management (FIGS. 4-6, 14, 16, 19, 21, 24); 6. Such software configured to managing information or workflow in the fields of risk identification, diagnosis, decision making, strategy, pre-emptive planning, or mitigation (FIGS. 4-6, 9-24); 7. Such software configured to scan and prevent penetration of computer systems by unauthorized computers and networks (FIGS. 6-9, 17, 22, 24); or 8. Such software for connecting to other services and software using API connectors (FIGS. 1, 4, 6-9, 12, 16, 21). The term “platform” refers to software or computing systems implementing functions described herein.

Various examples permit any, or any combination, of: (a) streamlining and automating risk-management functions such as identification, collection of answers, diagnosis, decisions, prioritization, management, building mitigation strategy, alerting of new risks or new controls to be aware of or are relevant; (b) collating and interrogating data sourced from the platform's users or their organizations (e.g., datasets having >1000 records, >100,000 records, or more); (c) collecting data from external sources (e.g., risk-relevant changes outside the client's immediate and internal environment) relevant to the system and (d) Collecting data in qualitative form (e.g., a collection of question and answer format, collecting documents, free text, yes/no question, or other)

As used herein, “Risk Data” can include, but is not limited to: quantitative and qualitative data—such as questions, statements and associated answers, sub-questions, sub-statements, sub-answers, parent-child questions and all associated treatments (e.g., advice), solutions (e.g., technical solutions, software, hardware or other), related risk scores, costs, likelihood, potential impact, due dates, changes in due date, decisions made regarding suggestions (such as treatments, solutions, changes, actions) or other items in the Stream (1c), or other relevant sections of the platform or application or meta-information. Each individual risk item (control) can have such associated values in addition to an organization or its departments (or other assessed units however defined by the organization itself) having an amalgamated measure based on the summary of individual risk control data.

Risk data can additionally or alternatively include any other data that defines and/or describes risk diagnosis, assessment, management, and strategy. For example, risk data can include the organization's risk posture at various times (e.g., substantially real-time). Risk Data can include information of which decision was made (e.g., as an enumerated value) in association with an identification of the corresponding recommendation or other item of Risk Data.

As used herein, “Meta-Data” can include, but is not limited to: action, time, location, industry, type, or other data points useful in grouping data for machine-learning purposes. As an example, time measurements related to a question/answer user interface can include: time taken to answer a question, time to score associated identified risk item, time used to identify treatments/solutions, time in completing remediations of identified risks, number of times and duration by which something has been delayed whether answering, scoring, treating, monitoring or other; time is also used to measure speed of such delivery, number of cycles (remediation attempts) taken to remediate, comments, re-scores, or re-assessment arrangements, associated costs, probabilities (or likelihood) of the specific risk materializing, or impact of such risks. Similar elements apply to actions taken, location of the organization or such actions taking place and more.

### Illustrative Techniques, Configurations, and Components

FIGS. 1A and 1B show a dataflow diagram of systems and techniques according to various examples. Some examples include categorizing, collecting and processing data to create a baseline dataset, e.g., as discussed with reference to FIGS. 8-24. FIGS. 1-6 describe various examples of systems, e.g., Machine Learning and Analytics components, such as those described with reference to FIGS. 8-24.

In various examples, decisions regarding suggestions (or recommended treatments and solutions) or other items in the Stream (1c) can include, e.g., decisions to accept a recommendation, accept a risk (e.g., refuse a recommendation), or postpone a decision. Other actions can take in the form of a confirmation (or a decision) of an advice, reminder, notification or alert by clicking Confirm, Decline, OK, or Skip. Various examples permit manual scoring and addition of other data such as treatment advice, complemented by technical solutions, links, documents, or other data.

Various examples include initial Scoping & On-Boarding, also referred to as “Discovery,” (1a) where clients are prompted to answer questions including but not limited to being about risk frameworks (e.g., GDPR or other examples discussed below) desired to be used in determining commands, or about the overall system or organization for which commands should be produced. The Scoping & On-Boarding helps users (a) identify or enter the number of Units to be assessed/monitored and (b) commence collecting Base Data. It also helps define and name these Units.

A Unit (e.g., out of n defined Units) is an identifiable and measurable entity or activity that is physically separate or divided within an organization. A Unit can be managed, monitored, and remediated independently of at least one other Unit. For example, a Unit is measured (can be assigned) by departments, locations, business lines, suppliers/vendors, projects or other identifiable metric (e.g., audit projects for an accounting firm, or M&A projects for lawyers). The system may launch a Scoping & On-Boarding on the overall organization without segmenting into Units or may do so on one or more specific Units.

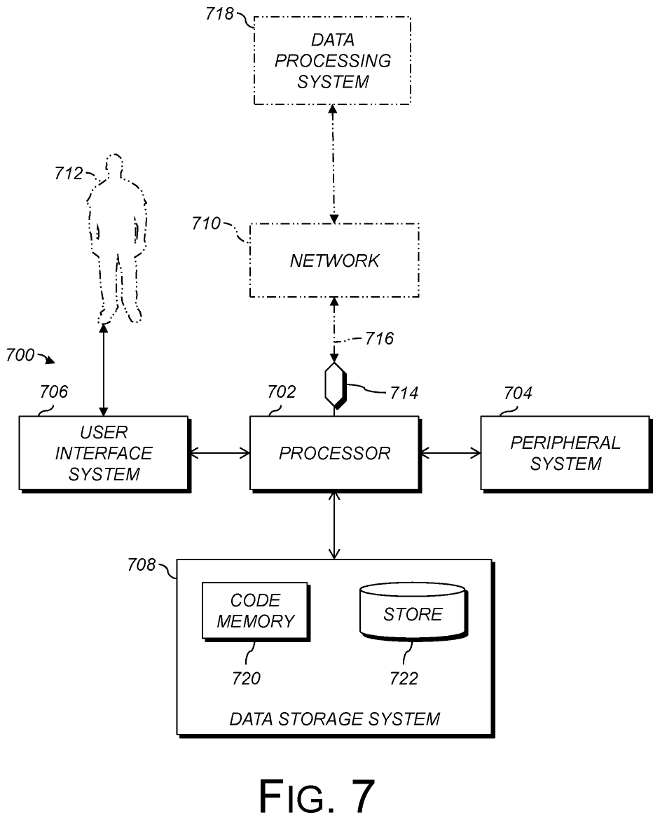

Units are then assessed, identifying Base Data for each Unit (Base Data[n]). For example, an organization could be composed of 10 Units in the following manner: Base Data[1] could be the London office, Base Data[2] could be the New York office, Base Data[3] could be the factory, and Base Data[4] Base Data[10] could be 6 suppliers. The combination of these 10 Unit Base Data can provide a single Base Data for the whole organization. See per-unit Change Data described herein with reference to, e.g., FIG. 9.

Additional information may optionally be collected about specific products or services used by the organization that can help the system build a more accurate Client Profile (1b). Client Profiles are populated and juxtaposed with resulting Base Data, Meta Data, Change Data and other data/processes for pre-emptive suggestions fed from Suggestions (8a).

Scoping & On-Boarding (1a) outputs a base Client Profile (1b) which includes the Base Data. Future Change Data can be compared to or collated with the Base Data giving a periodically updated (e.g., continually evolving) Client Profile.

In more complex or larger organizations Units may be arranged in a tree structure. E.g., an enterprise has a North America unit which divides into Country unit (Canada and USA), which then divides into States, then cities, then areas or street, then departments. Another organization may want to scope their Units as departments but across many locations.

Depending, e.g., on the size of the organization, various examples can include conducting: (a) one Scoping & On-Boarding for the entire organization; (b) one Scoping & On-Boarding which may lead to the identification of the need to conduct multiple Scoping & On-Boarding; (c) multiple Scoping & On-Boarding on multiple Units selected and connected under one organization.

In some examples, a Stream (1c) is a stream of questions or prompts to the customer, or other commands (FIGS. 9-24). In some examples, the system selects pertinent questions depending on the priority and urgency assigned to those questions by the system. The content of the Stream can also include alerts, requests for decisions to be made, updates, functions, patches, software to download, agents to download, or sequences of events to follow to implement a change, such as prompts to connect to software via API or any other content/information. The Stream prioritizes the controls and other information for the specific user. In some examples, a subsequent question within a Stream is asked only once a question has been answered or skipped. In some examples, the more and faster the user interacts with the system, the more questions are generated. In some examples, upon a specific answer to one question (e.g., a “yes” answer to “do you have a firewall?”), other questions are added (e.g., “has the firewall been set up?”, “is it updated?”, “is it on auto updates,”).

The questions within a Stream are initially led by Base Data questions. Subsequently, in some examples, the content of the Stream is determined based at least in part on the Change Data and prioritization of this data. For example, the Stream can include commands determined as discussed herein with reference to FIGS. 9-24. The assigned priority and urgency of a question (e.g., command) can be determined based at least in part on the existing Base Data, Meta Data in the Client Profile, Unit Profiles and respective Change Data for each Unit data and correlations in between. For example, a certain Change Data may be marked as a “critical”-risk question for Client Profile #1. Conversely the same Change Data question may be marked as a “low”-risk question or low priority alerts or information or actions for Client Profile #2.

In some examples, the Stream is configured to surface (e.g., present an indication of via a UI) risks of various importances (critical, high, medium, low, compliant) to a particular system (e.g., Client) on a per-system basis. In some examples, changes in Stream flow are determined based at least in part on the follow up answers, number and types of API connections established, actions taken, decisions made and remediation to any related questions, sub-questions, dependent questions or questions of diminished priority when compared to potential new suggestions. Each identified question/item on the Stream can act as a risk control (e.g., a preventive, detective, or corrective control). Each risk control can solicit an answer.

Based on the answers, the system can determine risk scores. An example risk-scoring mechanism is: 1—critical, 2—high, 3—medium, 4—low, 5—compliant or N/A; another is a score of 1-3; still another is a score indicating likelihood versus impact. Some examples can use compute risk scores based at least in part on adding weights, likelihoods, or impacts of risks, or costs of remediations. Various examples standardize or index scores from different scales into grouped comparable data.

Some examples include presenting a view of the Stream showing a list of Risk Controls associated with specific frameworks, categories, tags, or other criteria. Various examples permit authorized users to arrange, edit, or upload controls, or create their own controls (see below).

In some examples, questions can be presented in a flow and, depending on the answers given, sub questions (or child questions) may be suggested in order to fully cover a given topic. Presentation of sub-questions can prompt the collection of sub answers. This sub question and answer process can continue until the parent question has been satisfactorily answered/resolved. In other situations, an algorithmic logic can be set in stating “if a certain question is answered a certain way, carry out certain behavior” (e.g., include or exclude the next certain number of questions). In some examples, the system is configured to store program instructions implementing business logic, e.g., in LUA, JAVASCRIPT, or other scripting languages.

In some examples, custom questions can be added. Such questions may expand upon suggested questions or cover a different set of information or circumstances than existing questions. Some examples permit building custom questionnaires. These can be selected and launched (or launched as priority) within Streams in specific or all Units. In some examples, one or more of the questions answered are cross-checked to see if that question is also relevant to multiple frameworks. This permits improving efficiency of compliance by auto-filling across many frameworks.

In some examples, answers are offered as auto-filled suggested answers (already answered in to similar questions from other risk frameworks). In some examples, answers are copied to answer data for corresponding questions across other frameworks. In other situations, Answers can be auto-filled by data collected via connections established using APIs outside the system, e.g., to an organization's existing software. E.g., Apomatix API may extract number of employees within the organization or that specific Unit and fill in that Risk Control question. Data can be collected as Base Data from other software, and automatically offered as answers for the questions (controls) posed. These automatic responses are collected via the process of establishing links between one control, its corresponding possible answer(s) and respective Reaction or by collecting crowdsourced responses over multiple Data sets, providing a measure such as “80% of people are doing X to resolve this problem”. Such correlations are established as data is collected to offer Crowdsourced Data and insight to clients depending on their sector, size, industry, exposure of risks or activities and other factors. In some examples, as answers are submitted (whether manually, one by one, automatically or in bulk), some examples provide commands, e.g., suggested scores, treatments/solutions, due dates, or other relevant material.

In some examples, tags (whether manually placed by the user per question, or an administrator creating questions and establishing other associations) or automatically identified by text recognition software (relating to Risk Data) can be used to improve the accuracy of suggestions. The system can maintain a curated list of tags, e.g., provided by users or administrators. The system can reject misspellings, or inappropriate or irrelevant tags, by determining that they are not on the curated list. Tags can be derived from language analytics (e.g., location of keywords) of free text fields in risk-data items, e.g., event records (FIGS. 9-24), and added as tags associated with those risk data items. Some examples permit users to add their own free text tags.

In some examples, there can be a distinction on the platform between user tags and curated tags so that only some tags are used within the machine learning process. In some examples, curated tags are used. Other distinction may be introduced such as framework tags, category tags, or generic tags.

The client's Risk Profile (1d) can represent that Client's or Unit's particular risk status. Scoring can be applied to each individual risk or can be accumulated into a universal score for each Unit or combination of Units for the whole Organization. Each Unit or amalgamation of Units can be split into different tags, categories, or combination of such reports.

Example risk statuses can include, in some examples, those in Table 1. Other methodologies and measurements can be used. The boundaries shown in Table 1 can be adjusted, e.g., under user control.

TABLE 1

| Percentage of compliance with | |
|---|---|
| the selected framework(s) | Risk status code |
| <25% | Critical |
| ≥25% and <50% | High |
| ≥50% and <75% | Medium |
| ≥75% and <100% | Low |
| 100% | Compliant |

The system can produce a Risk Profile (1d) (e.g., a live or near-real-time representation) based on the Risk Data (e.g., Base Data and Change Data) that the client has completed and continues to provide via actions prompted by Change Data. In some examples, the Risk Profile (1d) can be presented by the platform to users, can be used to drive the dashboard, analysis, and reporting, or can be used to determine an overall risk score and strategy or be used to prompt further and continuous actions and prompts to enhance or strength the organizations risk posture.

In some examples, automated Discovery (2) is used to help build a more accurate Client Profile (1b) to increase the effectiveness of suggestions. The system uses machine learning (2a) techniques such as those described below to interrogate the clients' Risk Data, looking for key words and concepts that reveal areas of relevance to that client to expand the breadth of suggested risks to assess. Optionally, external sources may also be automatically interrogated by an external scanner (2b). Examples sources can include an organization's public-facing website, WIKIPEDIA, or whitepapers. External scanner (2b) can search for information to expand the client profile or validated other collected information (e.g., answers to questions). This information can include, e.g., a client's publicly listed partnerships with other entities, suppliers, clients, operating territories, locations of premises used by the client, information to further fill the Client Profile and listed technologies/hardware used. This can include port scanning, or sourcing of credit rating agency data or other publicly available datasets. External scanner (2b) can be used before presenting questions, e.g., to pre-fill questionnaires with answers determined by or derived from scanned information. Additionally or alternatively, external scanner (2b)can be used after receiving answers, e.g., to validate the provided answers. For example, after the question “is your firewall active?” is answered in the affirmative, port scanning can be used to determine whether the firewall is indeed functional.

Risk Assessment (4) is the process by which risks are assessed, e.g., using the Stream or other methodologies. In some examples, the system presents information from the Stream (1c) via a user interface. In other examples, as shown, a UI can present Stream entries, solicit responses, and provide the responses to the Risk Assessment (4) module.

The Risk Assessment (4) module receives Responses, e.g., an answer to a base question. As shown, depending on the answer, the Risk Assessment module may provide to the Stream subsequent questions or sub-questions in order to support or clarify details of the base question or other behavior.

Form Data can include, e.g., any data extracted and used from other formats/forms which provide explanatory, registry, log, or audit related data including but not limited to risk registry, asset registry, risk management, policy management, contract management, vendor risk management, or penetration test. This information can be collected from external tools (by uploads or inserted manually) or via API. Some example systems herein include software components to retrieve form data.

Usage Analytics (9a) can include implicit and explicit actions taken by the client. Explicit actions are actions such as deliberately dismissing a suggestion presented by the platform. Implicit actions are derived from the usage of the platform. For example, if the platform presents 3 possible suggestions and the user chooses one, the system can use the fact that the other options were not chosen to inform future suggestions.

In some examples, the user's answer can be or include a selection from a predetermined list of decisions. The system can take action based on the selected decision to provide an outcome. In some examples, the list of decisions can include choices for: accepting the answer, rejecting the answer and marking it as requiring further action, or postponing the action and attaching a new due date. At the new due date, the suggestion (8a) can again be provided, e.g., via the Stream (1c), a dashboard, a calendar, or other UI views.

Content Control (6) can include a gateway for new potential risk data to be marshalled. Data validation (6a) can process potential new risk data (e.g., generated by clients or provided by external sources) before being passed through to the Machine Learning Model (8b). This allows data to be validated before becoming or being used to determine or train a model to determine, a potential suggestion. In some examples, the Content Control process can monitor new data being fed into the model, and correct or discard if needed, e.g., using a machine learning model. Examples are discussed herein, e.g., with reference to FIGS. 14-16,19-21, and 24.

In some examples, the system can receive input (e.g., from users) to indicate that a suggestion or other item in the Stream (e.g., a suggested treatment/solution) is not helpful. Content Control can then discard similar items under similar circumstances. Similarity can be determined using a machine-learning model trained to determine similarity. The model can take as inputs the free text of an item or tags associated with the item. The system can include a module for receiving Manual Risk Input (6b), e.g., data entered by humans based on available sources such as whitepapers, information from partners, authorities, conferences, or policy or legislation changes. This information can be distilled into risk data to be fed into the machine learning model (8b), e.g., as described above. For example, keyword extraction and tagging can be performed. As with other forms of information added to the model, Clients affected by the new information can be notified and an Event (3b) can be triggered, pushing new questions into the client's Stream (1C). In some examples, (6b) can include receiving manually-entered data. The data can be converted into, or stored in, a common format including tags or freeform text.

In some examples, prior to textual data being fed into the Machine Learning Model (8b), the text can be run through Language Analysis (7). The Language Analysis process can determine what language the input is in, e.g., using vocabulary dictionaries. All text can be translated to a baseline language, e.g., English, to give a common base of knowledge to work from. Translation can be performed using automated translation services or integrated Al techniques. The (translated) text can then be analyzed for keywords that can be used to tag that data. For example, keywords can be extracted from textual data by TF-IDF analysis or other techniques for determining words that are representative of a document. The sentiment of the text may also be analyzed to give a rating on how severe the language of the text is (e.g., mildly-expressed sentiments such as “like” vs. strongly-expressed sentiments such as “can't live without”). In some examples, the sentiment metric can be used to improve the machine-learning model's accuracy. For example, a piece of risk data associated with a negative sentiment can weighted more heavily than a piece of risk data associated with a neutral sentiment.

The Machine Learning Model (8b) can use a variety of types of data to determine suggestions. Examples include but are not limited to: Keywords, Cost of the risk or of prevent or mitigating it (e.g., in money, wall-clock time, or computational resources), Probability of occurrence of the risk, Risk Frameworks, All Client Profile (1b) data (e.g., after anonymization), or Risk Data analytics. Risk Data analytics information can be sourced from the meta-information (Meta Data) extracted from an assessment process, such as time to completion, decision outcomes, due dates and Usage Analytics (9) across the platform. Risk Data can be passed through Language Analysis (7) prior to being provided to the machine-learning model. This process can extract key words which are combined with tags given to a piece of Risk Data that are used to generate suggestions.

Some examples use two levels of comparison when looking for relevant suggestions: micro and macro. The first is applicable to entities that have multiple units within the platform where a micro level comparison is used. Risk Data from the client's other units can be looked at and suggestions based on those Risk Data items can be made. These suggestions may have a metric attached to display why it was suggested, for example: “40% of your organizations units have this question”. The macro level of comparison is used in conjunction with the micro comparison to find similar entities within the platform and offer suggestions based on the usage of Risk Data. These suggestions may also have a metric showing the reason behind the suggestion, for example: “60% of your industry peers have this question”. These suggestions feed into the Stream (1c).

In some examples, the machine learning (8b) can include or be implemented using components shown in FIGS. 4-8. In some examples, the machine learning (8b) includes or is implemented using at least one of, or a combination of: at least one support vector machine (SVM); at least one decision tree (e.g., a decision forest); and at least one regression model.

Some examples use unsupervised training, or a combination of supervised and unsupervised learning. Training data for the system can be provided by any of the data sources described herein and shown feeding into (8b) in FIG. 1B. For example, external-risk data can be provided via Content Control (6). In partly-supervised training scenarios, e.g., Manual Risk Input (6b), the system can receive labels for individual training-data records, e.g., via a UI. In other examples, e.g., fully-unsupervised training scenarios, training data is not required to be labelled. In some examples, unsupervised training is performed using only, or substantially only, records that have passed content control (6). In some examples, supervised or partly-supervised learning is performed based on the tags on items, as described herein. The machine-learning model (8b), or at least a portion thereof, can be trained to predict tags based on attributes of input items.

In some examples, data does not get discarded from the model over time but the likelihood of being used decreases over time, e.g., in situations in which the related risk becomes less relevant. Using information gathered about the use rate over time allows the platform to take into account fading relevance. A “sliding window” can be used to gather the recent usage data and to ignore usage data past a certain point in time. This allows the platform to retain (e.g., in a searchable database) older data that may no longer be as relevant. Using this retained data, for example, if a client is looking specifically for something that has faded away (e.g., decreased in relevance below a predetermined threshold), the Risk Data is available for use. However, computational models can be trained based on more recent data. This can improve the accuracy of the models' outputs.

In some examples, individual records are not labelled manually but data is validated within Content Control (6) before being used within the model. In some examples, there is a feedback system in place using the Analytics (9) as discussed. The usage data and deliberate action of dismissing suggestions can be used to train the model or can be used as inputs to the model. The Content Control (6) can also allow for further feedback at the validation step.

Using the discussed sources of data, as noted above, the Machine Learning (8b) can use a combination of SVM, decision trees and regression algorithms to produce the desired results and this can expand and evolve over time to refine results. Training can be unsupervised or semi-supervised using the Analytics (9) data feedback to validate results and improve accuracy. For example, an initial model can be trained in a supervised manner, and later generations of model can be trained in an unsupervised manner on data collected during operation of the initial model.

In some examples, training data for the machine-learning (8b) model can include at least one of, or any combination of any of: content of the Risk Data, tags relevant to that data, keywords, usage data, feedback data, or Client Profile data. In some examples, tag(s) for a training-data record can be determined automatically based at least in part on keyword(s) associated with that record and context data. In some examples, clients can tag items in the Stream manually, and those tags can be copied to the corresponding training-data records.

In some examples, the machine-learning (8b) model is periodically retrained on a new set of training data that excludes data outside the sliding window. After a retraining operation, the machine-learning (8b) model can be operated to provide data of risks, questions, treatments, solutions, answers, or tags. After an operation phase has extended for a predetermined period of time, the model can be retrained, after which a new operation phase can begin.

In some examples, a Dashboard (10) can provide a summary view of determined risk(s) associated with a project, e.g., via a graphical user interface presented on an electronic display, or via another user interface. The dashboard can provide one or more views of the overall project data. These views can provide a range of granularity, e.g., from a very high level suitable to be displayed as an overview, to a very in-depth view for use by a user who is using the software to assess, mitigate, and create a risk strategy. In some examples, the Dashboard (10) displays a breakdown of the current risks and compliance with frameworks. At the high level, overview data such as risk scoring over time, cost analysis, or completion time line are displayed. Risk scoring over time can provide a broad overview of how the client's risk strategy has been evolving over time, and can highlight shortcomings.

In various examples, the Dashboard (10) can provide various visualizations. Visualizations can include, but are not limited to: graphs with configurable filtering and timeframe options, heat maps, or a timeline representation showing when milestones were achieved (such as reaching compliance with a framework). Example heatmaps can plot risk, likelihood of an adverse event vs. the severity of that event, and associated costs for preventing or mitigating a risk.

Overall statistics can be displayed summarizing metrics such as: time taken at each stage of assessment, breakdown of decisions, or how many due dates were missed. These types of statistics can help to identify failings in the assessment process that can be addressed by the client.

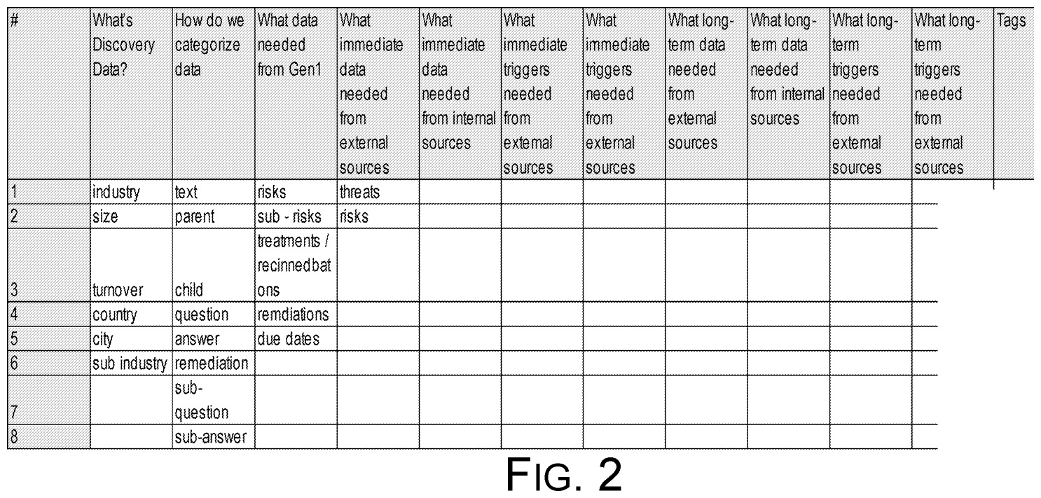

FIG. 2 shows examples of data types and values that can be stored, e.g., with respect to a Unit; in a record in the Risk Stream (FIG. 1 #1c); in a training-data, input, or output record of a machine learning model (e.g., FIG. 1 #8b); or in a manually-input risk record (FIG. 1 #6b) or suggestion (FIG. 1 #8a). In some examples, data can be collected from at least one of the following: Universities, Labs, Competitors, Intelligence, Reports, NGOs/charity, Books, Authorities, Standards, Policies, Legislation, Treaties, Files, Manuals, or lectures. In some examples, data can be collected within an organization from organizational units such as: CRM, HR, IT, Sales, or Procurement. Some examples can receive from external APIs information of threats, risks, vulnerabilities, reports, or scan files.

FIG. 3 shows an example process 300 for presenting information, e.g., to a user of a system. In some examples, controllable computing devices 808 (FIG. 8) (e.g., including components shown in FIG. 7 #700) can surface listed items via user interface system 706, e.g., in response to command 910 (FIG. 9) or other commands herein. In some examples, each box in FIG. 3 represents transmission of a command from a cloud server to a Web browser, and display by the Web browser of information in the command.

FIG. 4 shows an example machine-learning and data-analytics architecture 400, and related components. Gen 1 component 402 and Gen 2 component 404 can be implemented using components shown in FIG. 7 and can be part of or otherwise implemented by monitoring device 810, FIG. 8. In some examples, at least one function of Gen 1 component 402 and at least one function of Gen 2 component 402 are performed by a single component. In some examples, components 402, 404 represent subsystems of a combined component.

In some examples, the Gen 2 component 404 of architecture 400 can at least: (arrow “a”) receive Base Data, customer type, or other information from the Gen 1 component 402; (arrow “b”) surface or otherwise provide suggestions, auto fills: questions, answers, scores, treatments/solutions, or other outputs discussed above, or write information into the Gen 1 component 402; or (arrow “c”) can record user input (e.g., whether or not a particular suggestion was accepted) in response to provided information. In some examples, the Gen 1 component 402 includes a UI. In some examples, the Gen 2 component 404 includes a database. Gen 2 component 404 can additionally or alternatively interact with APIs (shown in phantom), as discussed above, e.g., cybersecurity or other APIs. Various examples of the Gen 2 system provide at least one of the following as outputs (arrow “b”): alerts; suggest questions; mini-questionnaires; treatments; solutions; costs, budget; priorities; pre-emptive actions (e.g., configuration commands or other commands discussed below); reminders; auto-fill scores, treatments, suggest solutions, etc.; benchmarking/crowdsourcing (e.g., information of vulnerabilities or risks faced by similar entities; lists of controls implemented by similar entities; due dates for actions in similar entities; scores of similar entities; industry average scores).

FIG. 5 is a dataflow diagram 500 showing operations for performing machine learning and data analytics as described herein, and related data sources. Gen 2 engine 502 (shown in phantom) can represent Gen 2 component 404. The cylindrical icons represent data stores, databases, or other data sources. The following symbols are used in this figure: X=due dates; Y=Geography; Z=Completion; T=Industry; D=Sector; R=Type of set up; K=Architecture used. Various examples are based on q1(x), q2(y), . . . q(n)(xy); Tq(y), T2(xy) . . . Tn(zx); or S1(z), S2(y) . . . Sn(zyx) computations. Some examples provide, analyze, search based on, or otherwise process tags and labels, e.g., relational tags. Some examples relate to frameworks such as GDPR; ISO27001; Cyber Essentials; NIST; or HIPAA. Various examples permit risks in complex and continually evolving problem domains to be more effectively diagnosed and permit managing the remediations of those risks (e.g., tech, non-tech, internal and external risks). Various examples provide continuous or continual monitoring, e.g., for cyber risk management. In various examples, the Gen 2 engine 502 determines CMs comprising: SVMs, decision trees, decision forests, or deep neural networks.

Various examples provide at least one of the following features: 1. automation of risk discovery, scoring, treatment and solution recommendations, understanding of relevant changes within internal, external, tech and non-tech environments (see, e.g., FIGS. 8-15); 2. evaluating known and potential risks based at least in part on at least: budget, scale of business, geography, level of risk, size, compliance needs, changes, number of people in your Risk Team, or other factors; 3. determining commands, e.g., to carry out actions to mitigate and keep risk low, or to present recommendations to take such actions (e.g., FIGS. 8-24); 4. determining estimates of associated likelihoods, costs, impacts of risk based on Machine Learning and crowdsourced data (see, e.g., FIGS. 16-24).

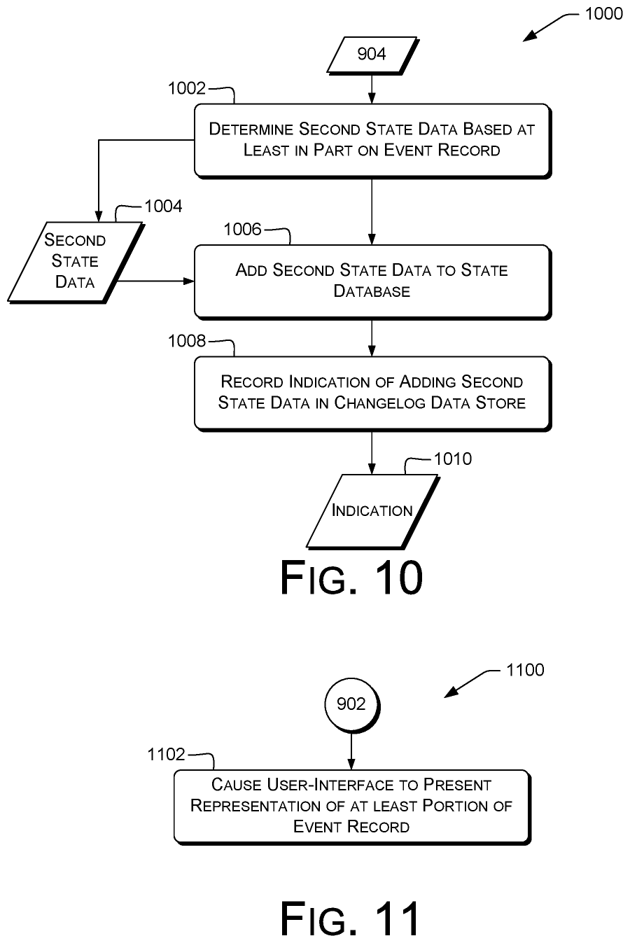

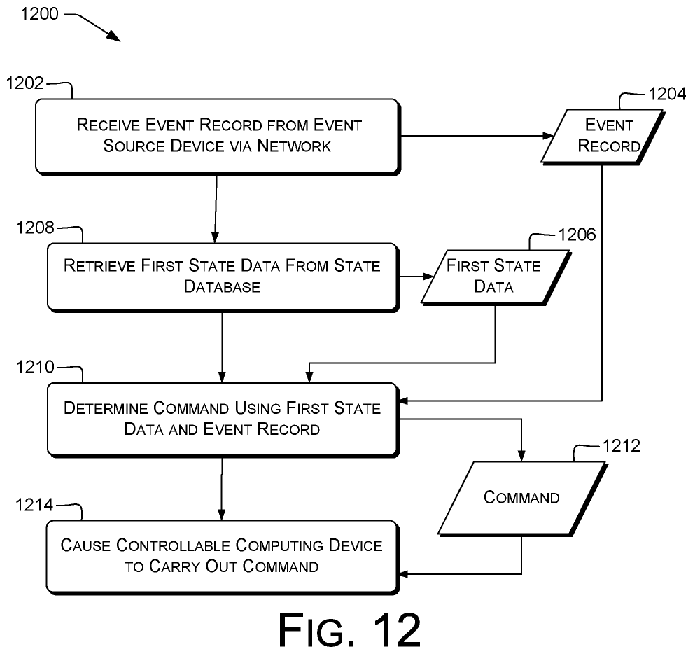

Various examples determine computational models using at least one of: Natural Language Processing (NLP), deep learning, or Probabilistic Graphical Models (PGMs). Various examples determine commands, e.g., commands to present recommendations of actions which users will find useful via a user interface (e.g., FIGS. 11, 15, 16, 18, 20), or commands to carry out those actions (e.g., configuration commands) (e.g., FIGS. 12, 22, 24).

In some examples, as noted above, Onboarding includes collecting Questionnaires (Qualitative data) and APIs (Quantitative data). Various examples use ML to learn a graphical structure to represent the organization being evaluated, e.g., a graph model of risks. The computational model determining the risk graph can be retrained periodically and can be operated periodically to update the risk graph based on change data. In some onboarding examples, that questions will start general (such as industry, #of employees, etc.), and as the system obtains more information it will begin to surface more specific/detailed questions. The result will be a set of questions and answers that can be included in Base Data.

Various examples take as Inputs at least one of: Question bank, company risk taxonomy, company organizational charts, external sources of data for clustering and tagging of questions, possible treatments/solutions (e.g., ways to mitigate risks).

In various examples, the risk graph can be a PGM determined, e.g., via MLE or other mathematical optimization techniques. Mathematical optimization can be performed with respect to an objective function that scores the overall comprehensiveness of the baseline risk assessment. The resulting graphical structure can have a node for each area of risk (e.g., by department or supplier). The node values can be risk weights, and the graphical structure can encode the relationships between different risk nodes (e.g., how risk in a given supplier affects risk in other (nodes) areas of the company. The risk score for an organization can be the cumulative risk score in the nodes of the organization's risk graph.

In some examples, Natural Language Processing (e.g., TF-IDF to find representative keywords in a text, other keyword analysis, or sentiment analysis) is used to tag questions with keywords and add structure. Clustering algorithms (such as T-SNE, PCA, or K-means) can be used to determine which groups of questions are relevant for a given organization.

In various examples, a baseline risk score (and possibly also detailed sub scores for each node) can be determined from the Base Data and a corresponding risk graph. The system can then monitor a variety of sources (e.g., receive event records) and update this risk graph based on new information.

In some examples, changes to the risk graph can be made in response to user input, e.g., indicating that the state of a Unit has changed (e.g., (new employee hired), that a Unit (e.g., department or vendor) has been created or removed, or that the relationship between two Units has been changed. Nodes or edges in the risk graph can be added, removed, or reweighted accordingly. For example, a learned risk graph can be re-learned based on new data.

In some examples, new data alters the risk associated with a node in the graph. A command can then be provided in response. In some examples, new data relates to a risk that was not effectively represented in the graph structure. For example, an event record may indicate a CVE for software used in an organization but not reflected in the questionnaires. The risk graph or the questionnaires can be updated in response.

In various examples, the Gen2 engine 502 takes as input the risk graph, data on proposed treatments/solutions, data regarding economic cost of risks, or other data shown or described herein. The engine 502 will attempt to find a set of proposed treatments/solutions that, if implemented, would reduce the organization's risk score (e.g., unweighted or weighted by projected economic cost). Treatments/solutions can be unweighted or can be weighted by expected implementation costs). In some examples, the system can lower risk score in response to past data showing that the organization consistently and efficiently implements proposed treatments/solutions, or increase risk score in response to past data showing the organization does not do so. Various examples perform Markov-Chain Monte Carlo simulation to estimate the effects that different combinations of proposed changes would have on the overall risk of the risk graph. Various examples use, in the simulation, data from users indicating effects of prior risks that were not completely mitigated. Some examples use a classification model, while some examples use a regression model. Some examples use an initial classification model, then use a regression model once enough data has been collected using the classification model. Various examples use cross validation data to determine a number of epochs used in training CMs.

In some examples, the system provides treatment/solution recommendations that identify risks (e.g., risks in the risk graph) that can be mitigated by accepting the recommendation. For example, a treatment/solution can be represented as a node in the risk graph, and the n risk nodes to which that treatment/solution node is connected with the highest weight can be reported.

In some examples, the Gen 2 engine 502 can include a risk-graph node representing risks that are unknown to the system. This can permit representing zero-days or other risks that become known at a discrete point in time. In some examples, the Gen 2 engine can use a combination of regression/classification techniques to build a predictive model about which questions will be useful to a particular organization.

In some examples, the Gen 2 engine 502 uses one or more types of training data. Some examples use supervised learning of a classification model trained on labeled classes. Some examples use semi-supervised or unsupervised learning of a regression model predicting outcomes of various risks and treatments/solutions. Raw features can include text or quantitative data. Text can be tokenized and embedding used to extract features from text (bag of words, Ngrams). TF-IDF weighting can be used.

FIG. 6 shows an example system 600 and example modules (numbered No1-No9) system 600 can include or communicate with. System 600 can represent system 700 or a Gen 2 system or engine as discussed above. Some examples use modules 1, 3, and 5 to provide pre-emptive cybersecurity.

In some examples, module 1 provides pre-emptive cyber security technology in response to a risk assessment generated from tech, non-tech, internal or external data (e.g., policies, best practices, procedures, systems, treatments, or solutions that affect cyber security). Examples of risk assessment are described above, e.g., the risk graph described herein with reference to FIG. 5. Some examples do, while other examples do not, check specific technical patches or perform end-point security operations such as antivirus scanning or network packet inspection.

In some examples, the system produces a command to present an indication to users if the setup of technology in an organization fails to mitigate a known vulnerability or does not comply with a security posture, risk framework, or regulation input to the system. In some examples, event records can indicate changes in cyber requirements. Command records can permit administrators to more rapidly act on those changes. Acting more rapidly can, in turn, positively affect cybersecurity. Various examples provide recommendations as to the action to be taken, how it should be performed, what products or services can be used, when, how quickly the action can be performed, the urgency of the action, or other factors.

In some examples, module 2 reduces the need for manual assessments found in some prior schemes. For example, the system can reduce the need to conduct yearly disruptive and expensive assessments. Module 2 can provide real-time continual updates to risk data.

In some examples, the system has data of an organization's structure, technology, or controls, e.g., from Gen 1 assessments or other discovery/onboarding discussed above,

Once a single assessment is done, module 2 can update the risk model, and can provide alerts (e.g., in the form of commands to user-interface devices) if the assessed organization may not stay within a predetermined risk-score range (e.g., below a threshold). Module 2 can coordinate the operation of other modules to accomplish this. For example, module 2 can select questions from a database to be asked of the user (e.g., prompts, FIG. 18). Module 2 can iteratively ask questions to gather data, then create a remediation plan (e.g., treatment/solution recommendation) (e.g., command(s) 910). Module 2 can use Machine Learning to correlate results, breaches, fails against suggestions, controls within specific metrics (region, industry, size, turnover, department).

Module 2 can permit users to login any time and see their and their suppliers' (or any Unit) real time (or near-real-time) risk postures. This can reduce delay in collecting risk data, which can directly improve system security. For example, vulnerability to a zero-day can increase over time for days or weeks after the announcement of the zero-day, as more adversaries begin to use the zero-day. Reducing the time required to learn about or adjust for the zero-day therefore directly, positively affects cybersecurity of an organization in a way that has no parallel in the pre-Internet world.

Module 3 can provide Real Time or interactive assessing and scoring tools that suggest remediations (treatments (e.g., advice) and solutions (e.g., technical)) as well as scores, due dates, or other pertinent information. Module 3 can communicate with module 9 to receive crowd-sourced data.

In some examples: As a user answers questions, module 3 can suggest a risk score, e.g., by operating the risk graph. Module 3 can suggest (e.g., auto-fill form fields) treatments/solutions, deadline, or other details. For example, module 3 can retrieve the most common solution/treatment for a particular risk from module 9 based on crowdsourcing data and can auto-fill that solution/treatment.

Module 4 can permit remaining secure as the risk environment changes. For example, module 4 can prompt users on topics such as: what should be changed; what should be assessed; or what should be removed.

Module 5 can process triggers for Gen2 and, in response, launch certain questions and assessments of specific questions (e.g., risk controls) due to certain external environmental changes. Triggers can be launched in two ways: from external APIs (data warehouses, risk reports, risk labs, universities, etc.); or by manual inputs prompted for by the system. Information can be solicited from Risk Officers, Data Controller, Manager, or other individuals who can provided information collected from conferences, news, or other sources that are not retrievable via an API.

Module 5 can provide risk discovery & recommendations. Module 5 can output indications of which items (risks) to assess, which risks to look for, which treatments and technical solutions are appropriate along with due dates, scores, or priority plans. Module 5 can output recommended actions to be taken to remain secure or maintain a predetermined risk posture.

Module 6 can provide Update & Checkup services to other modules, e.g., workflow or business-process modules. In some examples, before any decision is made, the decision is presented to the system for checking and approval. For example: before hiring a new employee, before the exit interview for a departing employee, before purchasing new software, before engaging a new supplier, before disengaging from a departing supplier, before opening a new office, before performing M&A activity, before engaging new customers (know your customer, KYC), or at other times, module 6 can collect information regarding the decision (e.g., proposed change) and provide a risk analysis.

In some examples, API (HR, Sales, Production, Accounting, Corporate, Procurement) connections can prompt the system that a change has occurred. Module 6 can, in response, prompt the user with a number of questions specific to the user's organization. Module 6 can additionally or alternatively collect other data (e.g., client size, applicable compliance frameworks, location, turnover, or other risk data previously answered). In some examples, module 6 can permit a Risk Manager or other user to manually select an action indicating a change. Module 6 can then provide questions.

Business Module 7 can provide views of costs of risks versus costs of remediation, promoting and monitoring decisions.

Treatment & Solutions engine module 8 can collect recommendations and maintain a directory of possible treatments (advise, methods, how a risk should be remediated, controlled, managed) and Technical Solutions (can be software, service, hardware or combination). The directory can include a plurality of possible actions from which modules 5, 6 can select.

Standardization, benchmarking, crowdsourcing module 9 can collect or report data regarding risks, vulnerabilities, solutions, treatments, expected remediation dates of your peers and market standards. For Example, module 9 can present prompts such as “Companies like yours have XYZ vulnerabilities, risks, have implemented the following controls, have deleted the following controls, have changed the following controls, have the following risks, have the following due dates, have the following risk scores, . . . ”. Additionally, or alternatively, module 9 can present industry-average risk scores or prompts such as “these controls seem to work with 80% of your peers.”

Various examples provide pre-emptive cyber resilience, or resilience against other risks. Various examples perform at least one of: digitally documenting identified risk elements, e.g., person, process, software used, suppliers used, relevant regulation and more; automated tracking of such risk elements; deploying automation powered by machine learning artificial intelligence to offer treatments, technical solutions, policy controls, due dates per risk or change in risk; understanding which treatments/solutions are likely to be effective for a specific client (based on type, industry, size, etc.) and specific risks; dynamically adjusting and learning in response individual changes; assessing multiple types of risks: e.g., at least one or, or all of: technical, non-technical, internal, direct and indirect external risks; flagging unaddressed or new risks as per relevant policies/regulation/or bespoke client controls; or providing continuous or continual monitoring.

Various examples include or provide at least one of: (not in order of importance or chronology) 1. Pre-emptive resilience to cyber risks (e.g., at least one of, or all of, 5 risk categories); 2. Reduced need for assessments (via automated risk discovery), reducing need for yearly, disruptive, and expensive snapshot assessments; assessing once and staying current; 3. Adaptation module: remaining secure as environment changes (after initial assessment, changes are automatically logged, tracked & alerted); ⋅ staying up to date with evolving/new risks; ⋅ periodically or continually flagging needed remediations & priorities; 4. “Staying ahead of risks”—continually on and supporting; ⋅ increasing chance that remediations are completed; 5. Real time diagnosis, strategy and manager; ⋅ helping to rapidly identify, diagnose, find relevant treatments/solutions, suggesting priorities and more; ⋅ presenting (near-) real-time risks of company, departments, suppliers; 6. Business module; ⋅ views of risk costs versus remediation costs; ⋅ company wide summaries of costs, spend & budgets; 7. Treatments and solutions directory: updated, crowdsourced and relevant recommendations; 8. empowers risk teams & interactive risk planning; 9. breach/treatment correlation showing which treatments/solutions are effective; 10. Crowdsourcing: What risks, controls, treatments, and solutions industry peers are adopting. Using industry best practices obtained from frameworks as well as from crowdsourced data across the relevant industry or other common users (e.g., commonality indicated by Meta-data similarity).

Various examples include a crowdsourcing data library built through analysis and placement of data from platform, affiliated universities, NGOs, and data repositories (E.g., tagging). Various examples include an Engine: a system & Data Manager that filters and inserts information and data into engine (e.g., FIGS. 1a-1b). Library items can be used by the engine to determine actions.

Various examples include a Platform (e.g., a Web interface) and an App, e.g., a mobile app or desktop application. The platform and app can provide bespoke, visual, (near-)real time alerts including proposed treatments/solutions. The platform can feed selected results and alerts to each end user based on their needs (e.g., risks applying to HR department/activities will be delivered to HR end-user, risks applying to IT, will be delivered to IT, and so on with Legal, Procurement, Accounting, Compliance, Corporate, etc.), answering the question: “How does this apply to the user's situation as represented by the data stored in the system?” Alerts can be provided to an end user, who can then provide inputs that are fed back into the library.

FIG. 7 is a high-level diagram showing the components of an example data-processing system 700 for analyzing data and performing other analyses described herein, and related components. The system 700 includes a processor 702, a peripheral system 704, a user interface system 706, and a data storage system 708. The peripheral system 704, the user interface system 706, and the data storage system 708 are communicatively connected to the processor 702. Processor 702 can be communicatively connected to network 710 (shown in phantom), e.g., the Internet or a leased line, as discussed below. Any of the processing components shown in FIGS. 1A and 1B, and discussed in Paper 1, can each include one or more of processor(s) 702 or systems 704, 706, 708, and can each connect to one or more network(s) 710. Examples of such processing components can include FIG. 1A #2a, 2b, 3a, 3b, 4, or 10, or FIG. 1B #5, 6, 7, 8, or 9. Processor 702, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 702 can implement processes of various aspects described herein, e.g., with reference to Paper 1 or Paper 2. Processor 702 and related components can, e.g., carry out processes for receiving data; processing the data to determine suggestions, questions, or other items; presenting the items via a Risk Stream; collecting user responses to items in the Risk Stream; anonymizing data; tracking workflow (e.g., schedules, work items, or costs); presenting user interfaces; receiving data from external APIs; performing analysis of free-form text and filled-in forms; or training computational models to provide Risk Stream items.

Processor 702 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise.

The phrase “communicatively connected” includes any type of connection, wired or wireless, for communicating data between devices or processors. These devices or processors can be located in physical proximity or not. For example, subsystems such as peripheral system 704, user interface system 706, and data storage system 708 are shown separately from the processor 702 but can be stored completely or partially within the processor 702.

The peripheral system 704 can include or be communicatively connected with one or more devices configured or otherwise adapted to provide digital content records to the processor 702 or to take action in response to processor 702. For example, the peripheral system 704 can include digital still cameras, digital video cameras, cellular phones, or other data processors. The processor 702, upon receipt of digital content records from a device in the peripheral system 704, can store such digital content records in the data storage system 708.

The user interface system 706 can convey information in either direction, or in both directions, between a user 712 and the processor 702 or other components of system 700. The user interface system 706 can include a mouse, a keyboard, another computer (connected, e.g., via a network or a null-modem cable), or any device or combination of devices from which data is input to the processor 702. The user interface system 706 also can include a display device, a processor-accessible memory, or any device or combination of devices to which data is output by the processor 702. The user interface system 706 and the data storage system 708 can share a processor-accessible memory.

In various aspects, processor 702 includes or is connected to communication interface 714 that is coupled via network link 716 (shown in phantom) to network 710. For example, communication interface 714 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WIFI or GSM. Communication interface 714 sends and receives electrical, electromagnetic, or optical signals that carry digital or analog data streams representing various types of information across network link 716 to network 710. Network link 716 can be connected to network 710 via a switch, gateway, hub, router, or other networking device.

In various aspects, system 700 can communicate, e.g., via network 710, with a data processing system 718, which can include the same types of components as system 700 but is not required to be identical thereto. Systems 700, 718 can be communicatively connected via the network 710. Each system 700, 718 can execute computer program instructions to perform functions described in Paper 1 or Paper 2. In some examples, system 718 can implement user interfaces, e.g., via a browser or smartphone app, and system 700 can implement back-end functions, e.g., determining a Risk Stream, transmitting items in the Risk Stream to system 718 for presentation (e.g., to a user), receiving responses to the items from system 718 (which can, e.g., provide the responses comprising or indicating user inputs), or training machine-learning models based on the responses.

Processor 702 can send messages and receive data, including program code, through network 710, network link 716, and communication interface 714. For example, a server can store requested code for an application program (e.g., a JAVA applet) on a tangible non-volatile computer-readable storage medium to which it is connected. The server can retrieve the code from the medium and transmit it through network 710 to communication interface 714. The received code can be executed by processor 702 as it is received or stored in data storage system 708 for later execution.

Data storage system 708 can include or be communicatively connected with one or more processor-accessible memories configured or otherwise adapted to store information. The memories can be, e.g., within a chassis or as parts of a distributed system. The phrase “processor-accessible memory” is intended to include any data storage device to or from which processor 702 can transfer data (using appropriate components of peripheral system 704), whether volatile or nonvolatile; removable or fixed; electronic, magnetic, optical, chemical, mechanical, or otherwise. Example processor-accessible memories include but are not limited to: registers, floppy disks, hard disks, solid-state drives (SSDs), tapes, bar codes, Compact Discs, DVDs, read-only memories (ROM), erasable programmable read-only memories (EPROM, EEPROM, or Flash), and random-access memories (RAMs). One of the processor-accessible memories in the data storage system 708 can be a tangible non-transitory computer-readable storage medium, i.e., a non-transitory device or article of manufacture that participates in storing instructions that can be provided to processor 702 for execution.

In an example, data storage system 708 includes code memory 720, e.g., a RAM, and store 722, e.g., a tangible computer-readable storage device or medium such as a hard drive or other rotational storage device, or a solid-state disk (SSD) or other purely electronic device. Computer program instructions are read into code memory 720 from store 722. Processor 702 then executes one or more sequences of the computer program instructions loaded into code memory 720, as a result performing process steps described herein. In this way, processor 702 carries out a computer implemented process. For example, steps of methods described herein, blocks of the flowchart illustrations or block diagrams herein, and combinations of those, can be implemented by computer program instructions. Code memory 720 can also store data or can store only code. In some examples, store 722 can include data storage, structured or unstructured, such as a database (e.g., a Structured Query Language, SQL, or NoSQL database) or data warehouse. In some examples, store 722 can include a corpus or a relational database with one or more tables, arrays, indices, stored procedures, and so forth to enable data access.

In the illustrated example, systems 700 or 718 can be computing nodes in a cluster computing system, e.g., a cloud service or other cluster system (“computing cluster” or “cluster”) having several discrete computing nodes (systems 700, 718) that work together to accomplish a computing task assigned to the cluster as a whole. In some examples, at least one of systems 700, 718 can be a client of a cluster and can submit jobs to the cluster and/or receive job results from the cluster. Nodes in the cluster can, e.g., share resources, balance load, increase performance, and/or provide fail-over support and/or redundancy. Additionally, or alternatively, at least one of systems 700, 718 can communicate with the cluster, e.g., with a load-balancing or job-coordination device of the cluster, and the cluster or components thereof can route transmissions to individual nodes.

Some cluster-based systems can have all or a portion of the cluster deployed in the cloud. Cloud computing allows for computing resources to be provided as services rather than a deliverable product. For example, in a cloud-computing environment, resources such as computing power, software, information, and/or network connectivity are provided (for example, through a rental agreement) over a network, such as the Internet. As used herein, the term “computing” used with reference to computing clusters, nodes, and jobs refers generally to computation, data manipulation, and/or other programmatically-controlled operations. The term “resource” used with reference to clusters, nodes, and jobs refers generally to any commodity and/or service provided by the cluster for use by jobs. Resources can include processor cycles, disk space, random-access memory (RAM) space, network bandwidth (uplink, downlink, or both), prioritized network channels such as those used for communications with quality-of-service (QoS) guarantees, backup tape space and/or mounting/unmounting services, electrical power, etc.

Furthermore, various aspects herein may be embodied as computer program products including computer readable program code (“program code”) stored on a computer readable medium, e.g., a tangible non-transitory computer storage medium or a communication medium. A computer storage medium can include tangible storage units such as volatile memory, nonvolatile memory, or other persistent or auxiliary computer storage media, removable and non-removable computer storage media implemented in any method or technology for storage of information such as computer-readable instructions, data structures, program modules, or other data. A computer storage medium can be manufactured as is conventional for such articles, e.g., by pressing a CD-ROM or electronically writing data into a Flash memory. In contrast to computer storage media, communication media may embody computer-readable instructions, data structures, program modules, or other data in a modulated data signal, such as a carrier wave or other transmission mechanism. As defined herein, computer storage media do not include communication media. That is, computer storage media do not include communications media consisting solely of a modulated data signal, a carrier wave, or a propagated signal, per se.

The program code includes computer program instructions that can be loaded into processor 702 (and possibly also other processors), and that, when loaded into processor 702, cause functions, acts, or operational steps of various aspects herein to be performed by processor 702 (or another processor). Computer program code for carrying out operations for various aspects described herein may be written in any combination of one or more programming language(s) and can be loaded from store 722 into code memory 720 for execution. The program code may execute, e.g., entirely on processor 702, partly on processor 702 and partly on a remote computer connected to network 710, or entirely on the remote computer.

In some examples, processor(s) 702 and, if required, data storage system 708 or portions thereof, are referred to for brevity herein as a “control unit.” For example, a control unit can include a CPU or DSP and a computer storage medium or other tangible, non-transitory computer-readable medium storing instructions executable by that CPU or DSP to cause that CPU or DSP to perform functions described herein. Additionally, or alternatively, a control unit can include an ASIC, FPGA, or other logic device(s) wired (e.g., physically, or via blown fuses or logic-cell configuration data) to perform functions described herein.

In some examples, a “control unit” as described herein includes processor(s) 702. A control unit can also include, if required, data storage system 708 or portions thereof. For example, a control unit can include a CPU or DSP and a computer storage medium or other tangible, non-transitory computer-readable medium storing instructions executable by that CPU or DSP to cause that CPU or DSP to perform functions described herein. Additionally, or alternatively, a control unit can include an ASIC, FPGA, or other logic device(s) wired (e.g., physically, or via blown fuses or logic-cell configuration data) to perform functions described herein. In some examples of control units including ASICs or other devices physically configured to perform operations described herein, a control unit does not include computer-readable media storing executable instructions. This disclosure expressly contemplates implementations of the described functions in various types of control units, including but not limited to software and FPGA implementations.

Various examples use machine-learning techniques, e.g., FIG. 1A #2A; FIG. 1B #6A, 7, 8B, or 9; Paper 2 pp. 14-18; or “Gen 2” as described in Papers 1 and 2. Various machine-learning techniques can be used for any of these components or modules. Example machine-learning algorithms usable herein include, but are not limited to, dynamic cascades, boost classifiers, boosting chain learning, neural-network classification, decision-tree or decision-forest support vector machine (SVM) classification, or Bayesian classification. An example classifier or model can be determined using AdaGrad or xgboost, for example. In some examples, a machine-learning model can be an example of a computational model. A computational model can include a model mapping inputs to outputs as described herein. In some examples, training and operation of a computational model can be carried out on the same device or on different devices. For example, a machine-learning model in FIG. 1B #8B can be trained and operated in a computing cluster. In another example, a machine-learning model in FIG. 1A #2A or FIG. 1B #6B can be operated at the same system that presents a UI to receive input of external documents or manually-specified risks.

Data can be processed, in various examples, using machine learning and data analytics methods, e.g., supervised or unsupervised learning methods. For example, a computational model can be trained, or operated on, the user-provided data. Example types of computational models that can be used to analyze or process the user-provided data can include, but are not limited to, at least one of the following: multilayer perceptrons (MLPs), neural networks (NNs), gradient-boosted NNs, deep neural networks (DNNs), recurrent neural networks (RNNs) such as long short-term memory (LSTM) networks or Gated Recurrent Unit (GRU) networks, Q-learning networks (QNs) or deep Q-learning networks (DQNs), decision trees such as Classification and Regression Trees (CART), boosted trees or tree ensembles such as those used by the “xgboost” library, decision forests, autoencoders (e.g., denoising autoencoders), Bayesian networks, support vector machines (SVMs), or hidden Markov models (HMMs). (A DNN can have at least two hidden layers. A neural network used for techniques described herein can have one hidden layer, two hidden layers, or more than two hidden layers.) Such computational models can additionally or alternatively include regression models, e.g., polynomial and/or logistic regression models (some of which can, e.g., that perform linear or nonlinear regression using mean squared deviation (MSD) to determine fitting error during the regression); linear least squares or ordinary least squares (OLS); fitting using generalized linear models (GLM); hierarchical regression; Bayesian regression; classifiers such as binary classifiers; decision trees, e.g., boosted decision trees, configured for, e.g., classification or regression; or nonparametric regression. Computational models can include parameters governing or affecting the output of the model for a particular input. Parameters can include, but are not limited to, e.g., per-neuron, per-input weight or bias values, activation-function selections, neuron weights, edge weights, tree-node weights, or other data values, e.g., weights, biases, intercepts, or other parameters for classifiers or other computational models. A decision tree can include, e.g., parameters defining hierarchical splits of a feature space into a plurality of regions. A decision tree can further include associated classes, values, or regression parameters associated with the regions.

The system can determine computational models, e.g., by determining values of parameters in the computational models. For example, neural-network or perceptron computational models can be determined using an iterative update rule such as gradient descent (e.g., stochastic gradient descent or AdaGrad) with backpropagation. Parameters can be stored in store 722. A training module stored in data storage system 708 can determine values of the computational model, e.g., using backpropagation in neural networks. A module stored in data storage system 708 can then use the determined values of the computational model to perform, e.g., extrapolation, forecasting, or other tasks described herein.

In some examples, training can be performed using the Theano package for PYTHON, or another symbolic/numerical equation solver, e.g., implemented in C++, C#, JAVASCRIPT, MATLAB, Octave, and/or MATHEMATICA. In an example using Theano, equations are defined symbolically in PYTHON code using Theano functions. Some examples can be implemented using, and/or can include, invocation(s) of the scikit-learn “fit( )” function to fit, e.g., gradient-boosted regression trees, linear functions, or other functional forms to regression data.

Equations defining a computational model can be expressed in a Theano symbolic representation. A cost function can be defined that computes a difference between training data and a prediction output from the Theano expression of the model. The Theano “grad” subroutine can then be called to symbolically determine the gradient of the cost function. The Theano “function” subroutine can be called to define a learning-step function that will update the model parameters based on the gradient of the cost function, e.g., according to a gradient-descent algorithm, and return the value of the cost function with the new parameters. To train the model, the learning-step function can be repeatedly called until convergence criteria are met. For example, the learning-step function can be given as input a randomly-selected minibatch of the training data at each call, in order to train the model according to stochastic gradient descent (SGD) techniques. In some examples, Theano can be used to train computational models using SGD with momentum 0.9 or a batch size of 100. Grid search can be used to select the learning rate for training, e.g., by performing training at each of a plurality of learning rates within a predetermined range (e.g., 0.0001, 0.001, 0.01, and 0.1). Alternatively, models can be trained using various learning rates and that model selected that most effectively satisfies acceptance criteria, e.g., of accuracy, precision, or training time. Example learning rates can include 0.1, 0.01, or 0.001. Gradient-clipping or dropouts can be used during training. For example, when the numerical value of the gradient exceeds a selected threshold, the gradient can be clipped at the selected threshold.

In some examples, the training module can determine computational model(s) based at least in part on “hyperparameters,” values governing the training. Example hyperparameters can include learning rate(s), momentum factor(s), minibatch size, maximum tree depth, maximum number of trees, regularization parameters, dropout, class weighting, or convergence criteria. In some examples, the training module can determine computational models in an iterative technique or routine involving updating and validation. The training data set can be used to update the computational models, and the validation data set can be used in determining (1) whether the updated computational models meet training criteria or (2) how the next update to the computational models should be performed.

In some examples, an RNN can include artificial neurons interconnected so that the output of a first unit can serve as a later input to the first unit and/or to another unit not in the layer immediately following the layer containing the first unit. Examples include Elman networks in which the outputs of hidden-layer artificial neurons are fed back to those neurons via memory cells, and Jordan networks, in which the outputs of output-layer artificial neurons are fed back via the memory cells. In some examples, an RNN can include one or more long short-term memory (LSTM) units.

Throughout this document, a “feature vector” is a collection of values associated with respective axes in a feature space. Accordingly, a feature vector defines a point in feature space when the tail of the feature vector is placed at the origin of the N-dimensional feature space. Feature vectors can often be represented as mathematical vectors of, e.g., scalar or vector values, but this is not required. The feature space can have any number N of dimensions, N≥1. In some examples, features can be determined by a feature extractor, such as a previously-trained computational model or a hand-coded feature extractor. Feature values can include numerical values, e.g., integers or real numbers. In some examples, the feature vector can include categorical or discrete-valued features in Table 1, e.g., given integer values or encoded as one-hot or n-hot data.

Training or operation can include feature-extraction operations. Examples can include averaging or otherwise smoothing input data, converting data between domains (e.g., between charsets, or text/numeric conversion), encoding, compressing, mapping through predetermined lookup tables, filtering, or sorting. In some examples, feature-extraction can include techniques for reducing dimensionality of data, e.g., rotations of feature vectors into different spaces, or principal-component analysis (PCA) or other techniques for determining reduced bases for input data.

FIG. 8 shows an example system 800 for monitoring and controlling a computing device via a network, and related data items. The system 800 can include the elements described below.

An event-source device 802 (e.g., a Question & Answer (Q&A) user interface (UI), API client device, or computer running a software agent to detect or report events) can be configured to collect data from external sources (e.g., risk-relevant changes outside the system's immediate and internal environment) relevant to users of system 800. The event-source device 802 can, e.g., collect of data from set formats delivered from various utility, organizational, security, cyber security or compliance tools such as vulnerability scans results, penetration test results, quality assurance test results or other Form Data. The event-source device 802 can then provide an event record, e.g., a JSON or other structured-text record, or other data indicating or representing an event. Examples are discussed herein, e.g., with reference to FIGS. 1A, 1B, and 4-6.

A state database 804 can hold first state data 806. The state database 804 can comprise any type of database, e.g., SQL, NoSQL, or graph. Various examples capture a set of risk data to serve as the Base Data of the initial assessment acting as an ongoing evolving benchmark. The first state data 806 can be or include the Base Data.

A controllable computing device 808 (which can represent system 700) can communicate via network 812. The controllable computing device 808 can be, e.g., a desktop or laptop computer (e.g., having a UI), or a network node (e.g., a firewall, router, or security appliance).

A monitoring device 810 (which can represent system 700) can be communicatively connectable with the state database 804 and, via at least one network 812, with the event-source device 802 and the controllable computing device 808. The monitoring device 810 can be or include a server (e.g., a cloud server) or process(es) or module(s) running thereon, or other type(s) of control unit(s) to perform functions herein with reference to FIG. 1A-6 or 9-24. Examples of control units are discussed herein with reference to FIG. 7. Monitoring device 810 can be configured to update, configure, or operate controllable computing device 808, in some examples.

Network 812 can include the public Internet, a private network, a restricted-access network (e.g., a cellular IMS network), or any combination of any number of such networks. Examples are discussed herein, e.g., with reference to network 710, FIG. 7.

FIG. 9 is a dataflow diagram illustrating an example process 900 for controlling a computing device via a network, and related data items. Process 900 can be performed, e.g., by a monitoring device 810 as shown in FIG. 8, which can include control unit(s) configured to perform operations described below. Examples of control unit(s) are discussed herein with reference to FIG. 7.

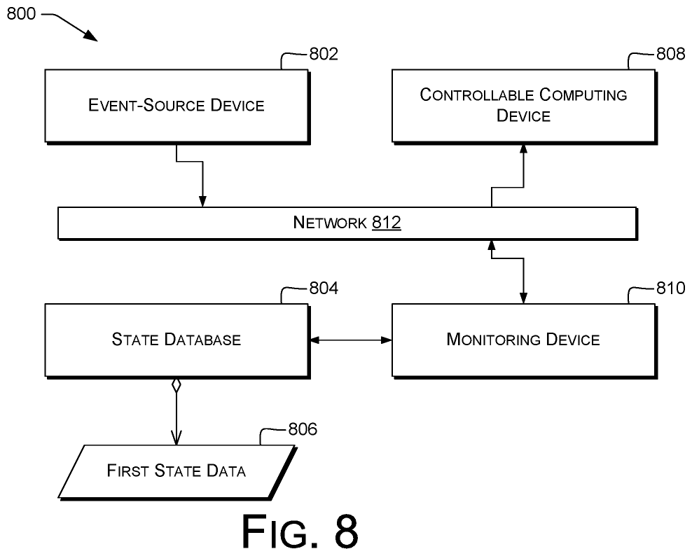

Operations shown in FIG. 9 and in FIGS. 10-24, discussed below, can be performed in any order except when otherwise specified, or when data from an earlier step is used in a later step. For clarity of explanation, reference is herein made to various components shown in FIGS. 1-8 that can carry out or participate in the steps of the example methods, and to various operations and messages shown in FIGS. 1-8 that can occur while the example method is carried out or as part of the example method. It should be noted, however, that other components can be used; that is, example method(s) shown in FIGS. 9-24 are not limited to being carried out by the identified components and are not limited to including the identified operations or messages.

At 902, the control unit can receive an event record 904 (e.g., indicating a notification of a change) from the event-source device 802. Examples of events and data in event records 904 are described herein with reference to FIGS. 1A-6. For example, event record 904 can include data of the event serialized in JSON, XML, or another structured-text form, or in an ASN.1 or other binary encoding rule form. The control unit can receive the event record, e.g., via a POST or other HTTP request, or another network transmission. The control unit can receive the event record 904 using communication interface 714, user-interface system 706, or peripheral system 704. Event record 904 can represent changes within the topology of a risk graph or other changes in risk data or associated data, any or all of which can be referred to for brevity as Change Data. Change Data can include, but is not limited to, change in risk calculations of the organization due to specific triggers or attention being brought up to changes within the organization or outside.

In various examples, Change Data can be acquired or accumulated from various sources including but not limited to internal sources (e.g., changes such as employees leaving, employees hired, suppliers on-boarded, IT systems integrated) or external sources (e.g., risk intelligence sources, market data, university or lab data, white paper, or discovery of a zero-day vulnerability).

In various examples, the control unit (e.g., of system 700) can receive Events (3) (e.g., event records 904) from sources including, but not limited to, Internal Sources (3a) External Feeds (3b), Enterprise Software collected data, Supplier data, External data, Form Data. In various examples, Events can have associated risk values, e.g., tags or risk scores such as those described above. In various examples, internally Sourced Events can be part of an automated process (such as an API integration with an HR system, accounting platform, CRM and more), or can be triggered manually by inserting specific data/changes into the system. External Feed (3b) Events are provided by External Risk Feeds (5). In some examples, the event record may indicate user authorization has been received to perform an action, e.g., adding controls to a compliance module. The authorization may have been solicited, e.g., by a command 910 (discussed below) determined earlier in time.

In various examples, the control unit can collect data from users and measure status-quo within each specific software environment (e.g., legal, HR, procurement, accounting, IT or other. (e.g., in HR system)). In various examples, the data can include Risk Data. For example, a user's Risk Data can be the combination of the Base Data they started with and any continual Change Data that the control unit continues to collate/calculate. In some examples, the Base Data can be tied to time. For example, Base Data in t=0 is different from Base Data t=0 +Change Data=Base Data t=1.

In various examples, External Automated Risk Feeds (5a) can be risk-data sources that can be automated and distilled to be validated. In some examples, the control unit can interrogate sources automatically. In various examples, sources can include, but are not limited to: feeds of documents (e.g., conference papers, journal articles, or whitepapers) from industry organizations, news feeds, or available APIs that provide information relating to external risks (e.g., new risks, threats or vulnerabilities). Application programming interfaces (APIs) can include, e.g., services offered by a server so that data can be retrieved from the server, e.g., via an HTTP request such as a GET to a Web Services or Representational State Transfer (REST) API endpoint. Data of risks identified using such external sources can be incorporated into a user's Stream via an Event (3b).

In various examples, the control unit can determine information relating to the software environment, e.g., how many employees, roles, or level of access for specific data, information and locations). Examples are discussed herein, e.g., with reference to onboarding and discovery (FIGS. 1A-6). The control unit can then determine changes (e.g., someone being fired, new vendor added, someone adds a device, travels) in a user's environment, e.g., by receiving event records at operation 902. The change can trigger the system 700 to react (e.g., send) the appropriate alerts, suggestive actions, treatments/solutions, and risk adjustment (e.g., 908, 912, 1210, 1214).

At 908, the control unit can determine, based at least in part on first state data 906 and the event record 904, a command 910. First state data 906 can represent first state data 806 (e.g., Base Data or other Risk Data, as it is stored at a time operation 908 is carried out). For example, the control unit can operate a trained computational model (e.g., FIGS. 1A, 1B, 5-7) to determine command 910 as output of the computational model. Examples are discussed herein, e.g., with reference to (8) (e.g., (8b)) and FIG. 5.

In various embodiments, the command 910 includes data indicating at least one of the following command types: creation of a user account; deletion of a user account; modification of the access privileges of a user account; modification of firewall rules; modification of routing rules; enabling of a device; disabling of a device; enabling of a device driver; disabling of a device driver (e.g., disabling the ability to use thumb drives such as USB sticks on a particular controllable computing device 808); enabling of a port; disabling of a port; installation of an update (e.g., a patch, or a full remove/install update cycle) (e.g., an update to software or firmware); presentation by a user interface of a toast, request to login, or another notification; presentation by a user interface of a prompt for yes/no or agree/disagree input, or other selection from a fixed list of choices; presentation by a user interface of a prompt for textual input; downloading of document file or other file (e.g., a policy DOC/PDF); adding of controls to a profile (Risk Data); adding of assets to an asset register (e.g., stored in state database 804 or elsewhere); adding of policies to, or updating of policies in, a database; requesting of authorization for a change to the state database. Command 910 can include associated data, e.g., the username of an account to be created or deleted, or text, graphical, or other media content of a toast or other notification or request. In some examples, command 910 may include data indicating at least one of: a policy, a process, a configuration of a device, an assessment of a vendor, or a document indicating proof of treatment or compliance. In various examples, command 910 can be sent to a desktop application, e.g., to cause the application to present a toast. Additionally, or alternatively, commands can be sent to other destinations (e.g., to cause updating of a user profile). Command 910 can represent a suggestion (8a).

In some examples, the command 910 can be a configuration command. The command 910 can be, e.g., an SNMP or other management-protocol packet describing or requiring a particular configuration, or a sequence of one or more commands to be executed to bring about a desired configuration or configuration change.

At 912, the control unit can transmit, via the at least one network, the command 910 to the controllable computing device 808 to cause the controllable computing device 808 to perform an action (e.g., present a toast, present a prompt requesting “yes” or “no” answer, or push change to controllable computing device 808) associated with the command 910. Examples are discussed herein, e.g., with reference to (1c), (8), and (10) (e.g., presenting suggestions), and (4).

In some examples in which the command 910 is a configuration command, operation 912 can include transmitting, via the at least one network, the configuration command to the controllable computing device 808 to cause a configuration change at the controllable computing device 808. For example, the control unit can send an SNMP message to an SNMP agent of the controllable computing device 808, or can establish an SSH or remote POWERSHELL connection to run a command sequence.

FIG. 10 is a dataflow diagram illustrating an example process 1000 performed by a monitoring device 810 such as that shown in FIG. 8 for controlling a computing device via a network, and related data items. In some examples, the monitoring device 810 can include control unit(s) configured to perform operations described below. Examples of control unit(s) are discussed herein with reference to FIG. 7.

At 1002, the control unit can determine second state data 1004 based at least in part on the event record 904. Examples are discussed herein, e.g., with reference to FIGS. 1A and 1B (e.g., updating Client Profile, Stream, Risk Profile based on outputs of Machine Learning model or information from other sources).

At 1006 the control unit can add the second state data 1004 to the state database 804. For example, the control unit can execute an SQL INSERT or other database-storage command.

At 1008 the control unit can record an indication 1010 of the adding of the second state data in a changelog data store. For example, the control unit can execute an INSERT or other database command with respect to a log table, e.g., separate from the data table. In some examples, when an item is changed or updated, the previous state can be retained in the form of indication 1010. This can permit stepping back through a change log in the changelog datastore or creating comparisons between states at different times. Operation 1008 permits maintaining the changelog.

FIG. 11 is a dataflow diagram illustrating an example process 1100 performed by a monitoring device 810 such as that shown in FIG. 8 for controlling a computing device via a network, and related data items. In some examples, the monitoring device 810 can include control unit(s) configured to perform operations described below. Examples of control unit(s) are discussed herein with reference to FIG. 7. Process 1100 can be carried out in a system comprising a user interface, e.g., a controllable computing device 808 having a user interface subsystem 706.

At 1102, the control unit can cause the controllable computing device 808 to present a representation of at least a portion of the event record 904. Examples are discussed herein, e.g., with reference to (1c). Operation 1102 can include, e.g., transmitting a Web page or AJAX update to the user interface (e.g., a Web browser, a mobile app running on a smartphone, or a desktop application). An AJAX update can include JSON or other structured text representing data to be presented, e.g., media content of a notification. In some examples, the user interface can be implemented by SLACK or another teamware provider, e.g., via an app or browser page provided by the teamware provider. Operation 1102 can include submitting data of the representation to a server of the teamware provider, e.g., via an app thereof, to cause the teamware provider to present the representation (e.g., a toast or other notification) via the user interface.

FIG. 12 is a dataflow diagram illustrating an example process 1200 for controlling a computing device and related data items. Process 1200 can be performed, e.g., by a monitoring device 810 such as that shown in FIG. 8, which can include control unit(s) configured to perform operations described below, e.g., in response to computer program instructions of the monitoring device. Examples of control unit(s) are discussed herein with reference to FIG. 7.

At 1202, the control unit can receive an event record 1204 (which can represent event record 904) from an event-source device 802 via a network. In various embodiments, the event record 1204 may represent notification of a change. Examples are discussed herein, e.g., with reference to operation 902.

At 1208, the control unit can retrieve first state data 1206 (which can represent first state data 806, 906) from a state database 804. For example, the control unit can perform a data query command such as an SQL SELECT.

At 1210, the control unit can determine, based at least in part on the first state data 1206 and the event record 1204, a command 1212 (which can represent command 910). Examples are discussed herein, e.g., with reference to operation 908.

At 1214, the control unit can cause a controllable computing device 808 to carry out the command 1212. In various embodiments, the control unit may cause the controllable computing device 808 to carry out an action associated with the command 1212. Examples are discussed herein, e.g., with reference to operation 912 (e.g., transmit command 1212 via a network to controllable computing device 808) and (8).

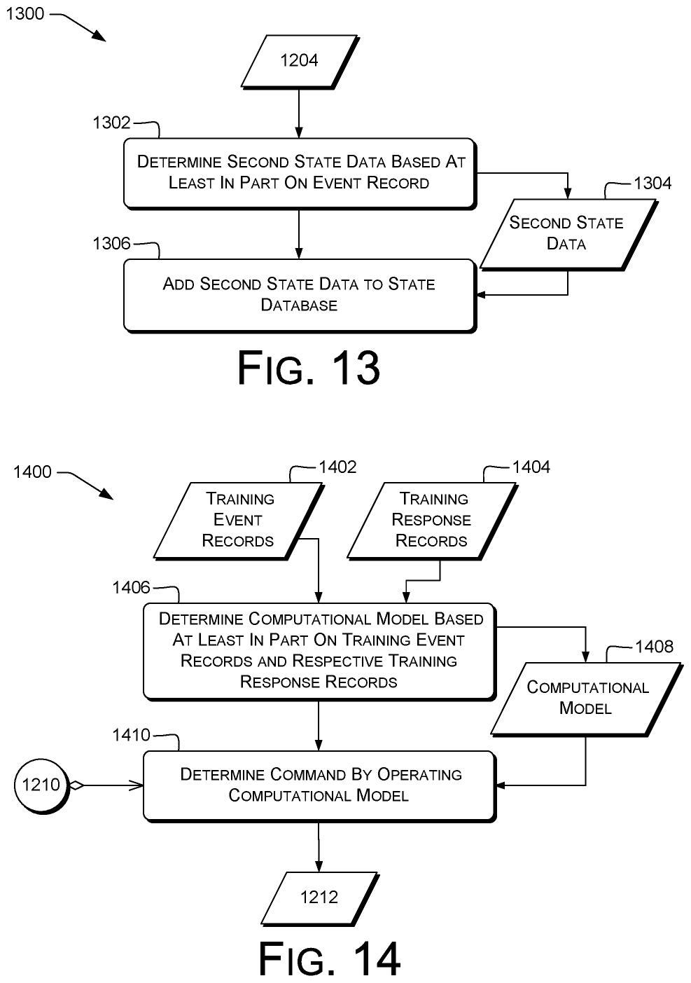

FIG. 13 is a dataflow diagram illustrating an example process 1300 for controlling a computing device and related data items. Process 1300 can be performed, e.g., by a monitoring device 810 such as that shown in FIG. 8, which can include control unit(s) configured to perform operations described below, e.g., in response to computer program instructions of the monitoring device. Examples of control unit(s) are discussed herein with reference to FIG. 7.

At 1302 the control unit can determine second state data 1304 based at least in part on the event record 1204. Examples are discussed herein, e.g., with reference to operation 1002.

At 1306, the control unit can add the second state data 1304 to the state database. Examples are discussed herein, e.g., with reference to operation 1006.

FIG. 14 is a dataflow diagram illustrating an example process 1400 for controlling a computing device and related data items. Process 1400 can be performed, e.g., by a monitoring device 810 such as that shown in FIG. 8, which can include control unit(s) configured to perform operations described below, e.g., in response to computer program instructions of the monitoring device. Examples of control unit(s) are discussed herein with reference to FIG. 7.

At 1406, the control unit can determine a computational model 1408 based at least in part on stored training event records 1402 and respective training response records 1404. Examples are discussed herein, e.g., with reference to FIGS. 1A, 1B, 5, and 6. For example, computational model 1408 can be trained to output suggested treatments/solutions, expected costs, expected due dates, or any combination of those, given as inputs selected elements of data in the stored training event records 1402 and respective training response records 1404 (e.g., organization location, organization size, controls implemented by an organization, other risks faced by the organization, or other data (internal or external) such as described herein with reference to FIGS. 1-9).

At 1410, the control unit can determine the command 1212 by operating the computational model 1408. Examples are discussed herein, e.g., with reference to (8), FIG. 5, and operation 908.

FIG. 15 is a dataflow diagram illustrating an example process 1500 for determining a computational model, and related data items. Process 1500 can be performed, e.g., by a monitoring device 810 such as that shown in FIG. 8, which can include control unit(s) configured to perform operations described below. Examples of control unit(s) are discussed herein with reference to FIG. 7.

At 1502, the control unit can present a representation at least a portion of the command 1212 via a user interface. Examples of ways of presenting representations are discussed herein, e.g., with reference to (1c), (10), and operation 1102. The representation can include text of controls to be added, configuration changes to be made, or other actions to be taken.

In various examples, the command 1212 can be displayed within a User's Profile (1b). The User Profile (1b) can include one or more metrics which can be used by the machine learning algorithms to return relevant suggestions at each stage of a Scoping & On-Boarding, during Additional Discovery, or when Change Data prompts are presented by the Stream.

In various examples, a User Profile can include, e.g., data disclosed during Scoping & On-Boarding, e.g., Base Data, Change Data, or a dynamic list of tags and potential areas of interest which the system 700 can populate via interrogating data filled in during regular use of the system 700 via Automated Discovery (2).

At 1504, the control unit can receive, via the user interface (e.g., #706), a response record 1508 associated with the command 1212 and a score record 1506 associated with the command 1212. Examples are discussed herein, e.g., with reference to (1c), (4), (7), or (10), FIG. 5, or FIG. 6 #6. For example, the control unit can receive an AJAX message from a browser-based UI, or receive a click or other event from a windowing system. In various embodiments, the control unit may receive the response record 1508 at a same time as the score record 1506. Alternatively, the control unit may receive the response record 1508 at a different time than the score record 1506. E.g., the command 1212 can include a suggestion, the response record 1508 can be received at a first time and indicate whether the user accepted the suggestion, and the score record 1506 can be received at a second, later time and indicate user feedback of how helpful (or not) the suggestion was.

In some examples, system 700 responds to changes and can surface or present up-to-date statistics and reports. In various examples, any changes occurring from any connected entities such as suppliers that effect a user's overall score record can be displayed in real time. Real-time data can additionally or alternatively include Events (3) and triggers coming from External Risk Feeds (5), which can be displayed in the user's Stream.

In various examples, when a new risk is determined via External Risk Feeds (5) or via Manual Risk Input (6b), the system 700 can prompt the user to start a Risk Assessment (4). In some examples, this Risk Assessment may come in the form of a single question (e.g., a control) in the Stream, set of multiple questions or could be an alert, a confirmation, or another form.

The response record 1508 received via the user interface can be at least one of: a thumbs up or down, a comment, stars voting (e.g., 1-star, 2-stars), a recording of whether the command was accepted, a recording of whether the accepted command was implemented, and/or a recording of how quickly (e.g., in milliseconds, seconds, minutes, or hours) the command was implemented.

In various examples, Base Data can be established within a User Profile. In some examples, Change Data can affect the Stream (1c). In some examples, a User's Profile can be updated as new Change Data becomes available or as answers are provided. In some examples, risk assessments, scores, remediations, re-scores, or other risk related functions are performed for risks identified from the Stream.

At 1510, the control unit can determine a second computational model 1512 based at least in part on the command 1212, the response record 1508, and the score record 1506. Examples are discussed herein, e.g., with reference to FIG. 5 and operation 1406. Second computational model 1512 can then be used in place of computational model 1408. Accordingly, process 1500 can permit retraining the model based on user feedback. Retraining can improve accuracy and pertinence, and thereby reduce the time required to respond to newly-discovered risks.

FIG. 16 is a dataflow diagram illustrating an example method 1600 for controlling a computing device and related data items. Method 1600 can be performed, e.g., by a monitoring device 810 such as that shown in FIG. 8, which can include control unit(s) configured to perform operations described below. Examples of control unit(s) are discussed herein with reference to FIG. 7.

Various examples can allow peer comparison, crowdsourcing, and benchmarking comparisons, by sharing anonymized data between users. This can permit the system 700 to determine patterns, share data analytics, share benchmarked or crowdsourced cross-relational anonymized Risk Data on others in the industry, or observe what is trending, what is correlated, or what is becoming a new norm. Risk Data from some or all users can be stored anonymously. This stored data can be part of Collaborative Data and can be used in training the machine-learning model to provide suggestions to a user.

At 1604, the control unit can store first state data 1602 (which can represent first state data 806, 906, 1206) in a state database 804, the first state data 1602 associated with a first data source (e.g., a second user or organization). Examples are discussed herein, e.g., with reference to first state data 906 or operation 1006. In various embodiments, the first data source can be associated with a first user of a plurality of users. Examples of state data are described herein with reference to operation 1208.

Various examples capture a set of risk data to serve as the Base Data of the initial assessment acting as an ongoing evolving benchmark.

In various examples, Risk Data can be tagged by users for later use as part of reporting. In some examples, tagged data can be passed to the Machine Learning Model (8b). The Risk Data can then be anonymized and passed to the Content Control (6a) to add to the breadth and accuracy of the Machine Learning Model (8b). Custom questions can also be passed into Automated Discovery (2) (see below).

In various examples, the above-described data can be amalgamated and crowd-sourced to power the system's Machine Learning engine to allow predictive modelling, suggestive treatments/solutions, risk scores, alerts and actions/communication to a user to help them reduce/mitigate their live and potential risks. System 700 can review the identified data sources and when identify trends, insight, correlations between what controls are successful in preventing breaches, which risk controls are better than others, better suited than others, and other such insight. By feeding through Machine Learning, the production of results continually becomes more accurate, including suggestions which in return trigger further actions, which in return result in further enhancement in security, reduction of risk, and improvement of user processes to help organizations build and maintain their risk management in a pre-emptive manner, mathematically optimize their operations, reduce cost, and build an effective strategy.

At 1608, the control unit can store second state data 1606 (which can include data of any of the types described herein with reference to first state data 806, 906, 1206) in the state database 804, the second state data 1606 associated with a second, different data source. Examples are discussed herein, e.g., with reference to operation 1006. In various embodiments the second, different data source can be associated with a second user of the plurality of users that is different from the first user. Examples of state data are described herein with reference to operation 1208.

At 1610, the control unit can determine a computational model 1612 based at least in part on the first state data 1602. The computational model 1612 can be a machine-learning model. Examples are discussed herein, e.g., with reference to operations 1406, 1510. In various examples, the machine-learning model can utilize Collaborative Data (8), which can include a collection of risk data, e.g., collected from multiple (e.g., all) users of system 700, along with the machine learning used to determine suggestions. Risk data can be stored or used by the machine-learning model (e.g., 8b). In various examples, as the system 700 collects more data, the model (e.g., 1612) can be retrained. Data can be validated and filtered via Content Control (6) before being provided to the machine-learning model.

At 1614, the control unit can receive an event record 1616 associated with the second data source (e.g., a second user or organization). In various embodiments, the event record 1616 is received via a network or other communication interface. Examples are discussed herein, e.g., with reference to operations 902, 1202.

At 1618, the control unit can operate the computational model 1612 based at least in part on the event record 1616 to provide a command 1620. Examples are discussed herein, e.g., with reference to operation 1410.

In various examples, a Scoping & On-Boarding begins with a questionnaire (e.g., command). The questions may be similar to questions used for other users or tailored to a particular user. Scoping & On-Boarding may use reference questions from any number of risk frameworks (e.g., ISO27001, GDPR, HIPAA, one or more custom frameworks, or other frameworks or bespoke/tailored questions): one, more than one, or a combination of at least portions of at least two frameworks, depending on the size, regulatory requirements, business needs and complexity of the user. Use or change of frameworks can vary due to numerous factors that include but are not limited to: relevant industries, locations, size of the organization, relevant regulatory or compliance frameworks, and turnover.

In various examples, the initial Scoping & On-Boarding questions within the Stream (1c) can be derived from a core set of fixed questions within the system 700 from specific frameworks. Depending on various factors including but not limited to Base Data, provided answers, Meta Data, Change Data, and User Profile, the Stream (1c) can direct the set of questions and help a user identify, assess, decide, prioritize, treat, and monitor risk controls and other relevant information.

In various examples, suggestions can be determined based at least in part on that user's profile or contextual information. Contextual information can include, e.g.: the current framework the user is investigating (if applicable), or what kind of suggestion items are required to be looked up whether that is a question, answer, treatment/solution, or other portions of the Risk Data.

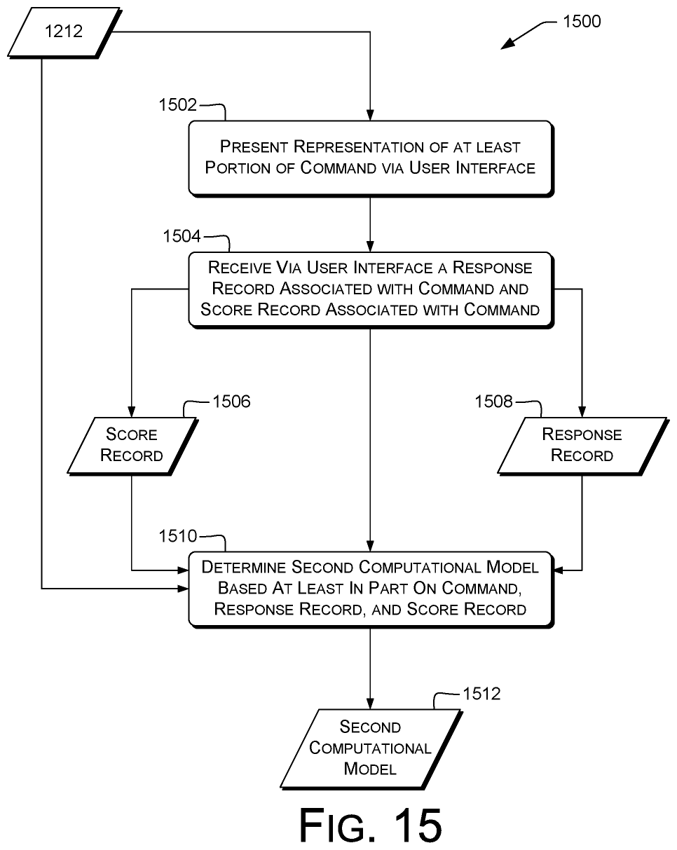

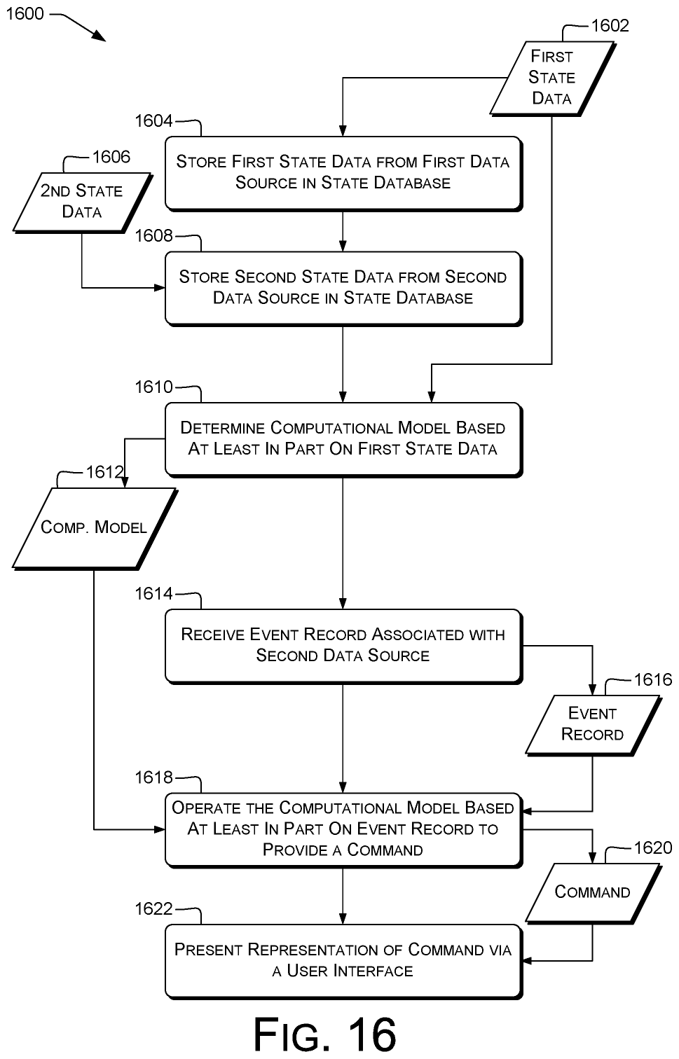

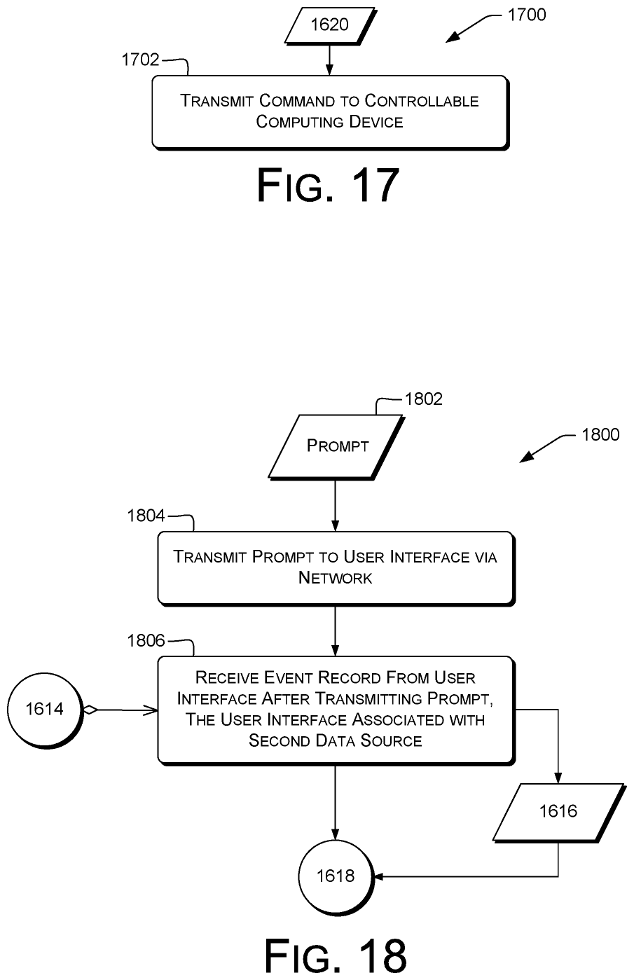

At 1622, the control unit can present via a user interface, a representation of the command 1620. Examples are discussed herein, e.g., with reference to 1502. The representation can indicate, e.g., what the control unit is proposing, or what the control unit is proceeding to do. Accordingly, operation 1702 (FIG. 17) can be performed after, or in parallel with, operation 1622. In various embodiments, the representation of the command 1620 can be presented as an alert (e.g., in Gen 1 (FIG. 4), a recommendation (or suggestion) is displayed in platform at login. Additionally, a user can receive at least one of an email, text message, and more, notifying the user to login. An alert can be presented via a desktop application installed on the controllable computing device 808; additionally, or alternatively, the alert can be received via an application installed on a mobile computing device.

In various examples, while a user (or multiple users individually or corporately) answers and interacts with the Stream (1c), the system 700 can display the risk frameworks (e.g., IS027001, HIPAA, PCI DSS) that are currently activated. The user can override suggestions and pick a specific framework to prioritize. In some examples, if no frameworks are selected, questions are prioritized without regard to which specific framework defines the question or control (e.g., out of a predetermined list of applicable frameworks).

In some examples, the system 700 can present a Risk Status. The Risk Status can include a risk measure. In some examples, the Risk Status of the user may continually be shown next to the Stream (1c). In some examples, access to the Risk Status is limited by permissions assigned to particular user accounts. In some examples, users can, via the system 700, request access to the risk profile of a supplier or other external organization.

In various examples, the user can be given a recommendation (e.g., suggestion(s) (8a)) via a Machine Learning (8b) algorithm. The recommendation can be provided to the user as elements in the Stream (1c). In response, the user can choose to use the recommendation, ask for more recommendations, or input a custom response (e.g., freeform text). Usage Analytics (9a) can be tracked and fed back into the Machine Learning (8b) model to add to the Collaborative Data (8) gathered from all users on the platform to enhance scope or accuracy of suggestions. In some examples, a custom response (and any associated Meta Data whether time taken to answer, due dates accepted, costs allocated) can be anonymized and added to the Collaborative Data (8) (e.g., to potentially be provided as a suggestion for another user in the future). In various examples, when an item is changed or updated, the previous state can be held so that a user can step back through a change log or create comparisons between states at different times.

FIG. 17 is a dataflow diagram illustrating an example method 1700 for controlling a computing device and related data items. Method 1700 can be performed, e.g., by a monitoring device 810 such as that shown in FIG. 8, which can include control unit(s) configured to perform operations described below. Examples of control unit(s) are discussed herein with reference to FIG. 7.

At 1702, the control unit can transmit the command 1620 to a controllable computing device 808 to change operation of the controllable computing device 808. Examples are discussed herein, e.g., with reference to operations 912, 1214.

FIG. 18 is a dataflow diagram illustrating an example method 1800 for controlling a computing device and related data items. Method 1800 can be performed, e.g., by a monitoring device 810 such as that shown in FIG. 8, which can include control unit(s) configured to perform operations described below. Examples of control unit(s) are discussed herein with reference to FIG. 7.

At 1804, the control unit can transmit, via a network to the user interface, a prompt 1802 (e.g., a question viewed through a browser or app). Examples of prompting are discussed herein, e.g., with reference to operations 1102, 1502.

At 1806, the control unit can receive the event record 1616 from the user interface after transmitting the prompt 1802, the user interface associated with the second data source. Examples are discussed herein, e.g., with reference to operation 1504. The event record 1616 can represent or include, e.g., an answer to a question given in prompt 1802. Operation 1806 can include detecting an event (e.g., click on a “Submit” button, or text entry) at the user interface, or receiving event record 1616 via an HTTP or other network request or response.

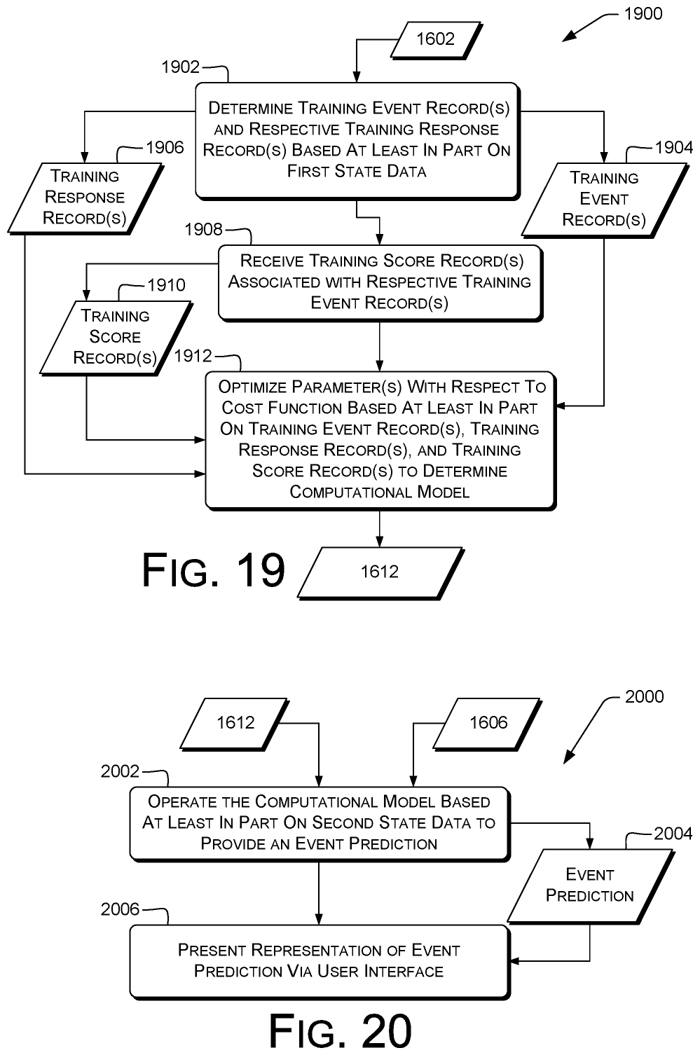

FIG. 19 is a dataflow diagram illustrating an example method 1900 for determining a computational model and related data items. Method 1900 can be performed, e.g., by a monitoring device 810 such as that shown in FIG. 8, which can include control unit(s) configured to perform operations described below. Examples of control unit(s) are discussed herein with reference to FIG. 7. The computational model can, e.g., predict a set of treatments/solutions that will reduce risk-associated costs or reduce risk score, e.g., determined as described above.

At 1902, the control unit can determine, based at least in part on the first state data 1602, one or more training event records 1904 (which can represent event records 904, 1204, 1616) and respective training response records 1906. Examples are discussed herein, e.g., with reference to FIG. 5. At least one of the training response records 1906 indicates an action of a plurality of actions. A training event record 1904 can represent a particular event, and the respective training response record 1906 can indicate an action that was taken in response to that event. Additionally, or alternatively, the respective training response record 1906 can indicate that no action was taken in response to the event. The plurality of actions can include possible responses to various risks. Responses can be, e.g., added to the system manually, learned over time, received from users, or any combination.

In various examples, the action can be based on system analytics. Analytics (9) is the process by which system 700 monitors and tracks user responses to suggestions (e.g., recommendations) and the outcomes. Suggestion Usage (9a) can tracked in two ways. The first will monitor deliberate user interactions such as dismissing a suggestion. The second will be via passive user interaction where in if the user has not actively selected a suggestion but has passed it by and either writing/overwriting a custom response or has selected another suggestion instead. In some examples, penalties are associated with suggestions during training of machine-learning models. In some examples, passive user interaction is assigned a lesser penalty than is the deliberate action of dismissing a suggestion. The penalties can be provided to the Machine Learning Model (8b) to improve accuracy of suggestions.

In various examples, the system 700 can determine a respective Treatment (one of the possible outputs of (4); outputs can include any of: treatment, solution, decision, cost, probability, validation, due date or other material) to be included in the suggestion. A treatment can include advice or can specify a Solution, e.g., some software, tools, or a certain technology.

At 1908, the control unit can receive one or more training score records 1910 associated with respective training event records of the one or more training event records 1904. Examples are discussed herein, e.g., with reference to operation 1504. Training score records 1910 can indicate how effectively the associated action remediated the corresponding risk, cost metrics associated with the action, or other data regarding the performance of the action.

In various embodiments, system 700 can use End-To-End metrics (9b) to track the overall platform usage. Data such as due dates and decisions can be applied to the Machine Learning Model (8b) in order to find which suggestions are most effective. Data relating to costs, probability and potential impact can be stored along. Additionally, or alternatively, additional meta data can be stored on, e.g.: time taken to complete the individual risk assessment, time taken on each step, or information on the back and forth process between multiple users of the system who share responsibility for risk management, or among whom such responsibility is apportioned or divided.

At 1912, the control unit can mathematically optimize at least one parameter with respect to a cost function based at least in part on the training event records 1904, the training response records 1906, and the training score records 1910 to determine the computational model 1612. Examples are discussed herein, e.g., with reference to FIG. 5. The resulting computational model 1612 is configured to receive as input at least a portion of the event record 1616 and the computational model 1612 is configured to provide as output the command 1620 indicating an action of the plurality of actions.

FIG. 20 is a dataflow diagram illustrating an example method 2000 for controlling a computing device and related data items. Method 2000 can be performed, e.g., by a monitoring device 810 such as that shown in FIG. 8, which can include control unit(s) configured to perform operations described below. Examples of control unit(s) are discussed herein with reference to FIG. 7.

At 2002, the control unit can operate the computational model 1612 based at least in part on at least some of the second state data 1606 to provide an event prediction 2004 (e.g., a determination of a risk “R”). Examples are discussed herein, e.g., with reference to FIG. 5 and operations 908, 1210. Event prediction 2004 can include, e.g., information regarding a possible future risk R.

At 2006, the control unit can present, via the user interface, a representation (e.g., text such as “users in your industry experience risk R”) of the event prediction 2004. Examples are discussed herein, e.g., with reference to (1c), (3), or (10), or operations 1102, 1502, 1804.

In various examples, a plurality of users within the same sector, industry, location or type can utilize system 700. The collected data (e.g., Risk Data, Collaborative Data), are combined and analyzed by Machine Learning to understand correlations, trends, and insight. For example, a first user can be notified (operation 2006) by system 700 (using crowdsourced data) that “75% of similar users have encountered the following risks” or “67% of users in your industry have adopted the following risk controls, would you like to import them and apply them” or “80% of users in your industry are spending 30% less on security than you are,” or others.

In various examples, the system 700 can utilize Machine Learning of industry best practices, insights, trends, and correlations between various factors (e.g., risks, threats, vulnerabilities, solutions, treatments, patches, technology, policies). In various examples, the system 700 can provide Pre-Emptive relevant alerts to users.

FIG. 21 is a dataflow diagram illustrating an example method 2100 for controlling a computing device and related data items. Method 2100 can be performed, e.g., by a monitoring device 810 such as that shown in FIG. 8, which can include control unit(s) configured to perform operations described below. Examples of control unit(s) are discussed herein with reference to FIG. 7.

At 2102, the control unit can receive, via the user interface, a response record 2104 associated with the command 1620 and a score record 2106 associated with the command 1620. Examples are discussed herein, e.g., with reference to operation 1504. In various embodiments, operation 2102 occurs after operation 1622 of FIG. 16. In various embodiments, the control unit may receive the response record 2104 at a same time as the score record 2106. Alternatively, the control unit may receive the response record 2104 at a different time than the score record 2106.

In various embodiments, the command 1620 can include a suggestion. The response record 2104 can indicate whether the user accepted the suggestion, and the score record 2106 can be received later as user feedback of how helpful (or not) the suggestion was. Examples are discussed herein, e.g., with reference to (9) and FIG. 15.

At 2108, the control unit can determine a second computational model 2110 based at least in part on less than all of the first state data 1602, the command 1620, the response record 2104, and the score record 2106. Examples are discussed herein, e.g., with reference to operation 1510. In various examples, the control unit excludes aged-out data of the first state data 1602, the command 1620, the response record 2104, and the score record 2106, when determining the second computational model 2110. In various examples, the second computational model 2110 can be used to retrain the system 700 with updated data. A sliding window of data can be used, e.g., beginning n days, weeks, or months before the present time and ending at the present time.

At 2112, the control unit can receive, via a network, a second event record 2114 associated with the second data source. Examples are discussed herein, e.g., with reference to operation 1614.

In various examples, the system 700 may suggest additional framework questions/questionnaires that may be relevant to a user based on relevant data acquired within the first Scoping & On-Boarding, the process set within the Scoping & On-Boarding stage, the type of user, or the answers provided. These additional Scoping & On-Boarding and assessments can, as above, feed into Base Data t=0 (if done initially) or act as Change Data (e.g., the second event record 2114), if initiated after implementation of the first Change Data (e.g., event record 1616).

At 2116, the control unit can operate the second computational model 2110 based at least in part on the second event record 2114 to provide a second command 2118. Examples are discussed herein, e.g., with reference to operation 1618.

At 2120, the control unit can present, via the user interface, a representation (e.g., see discussion of FIG. 20 above) of the second command 2118. Examples are discussed herein, e.g., with reference to operation 1622.

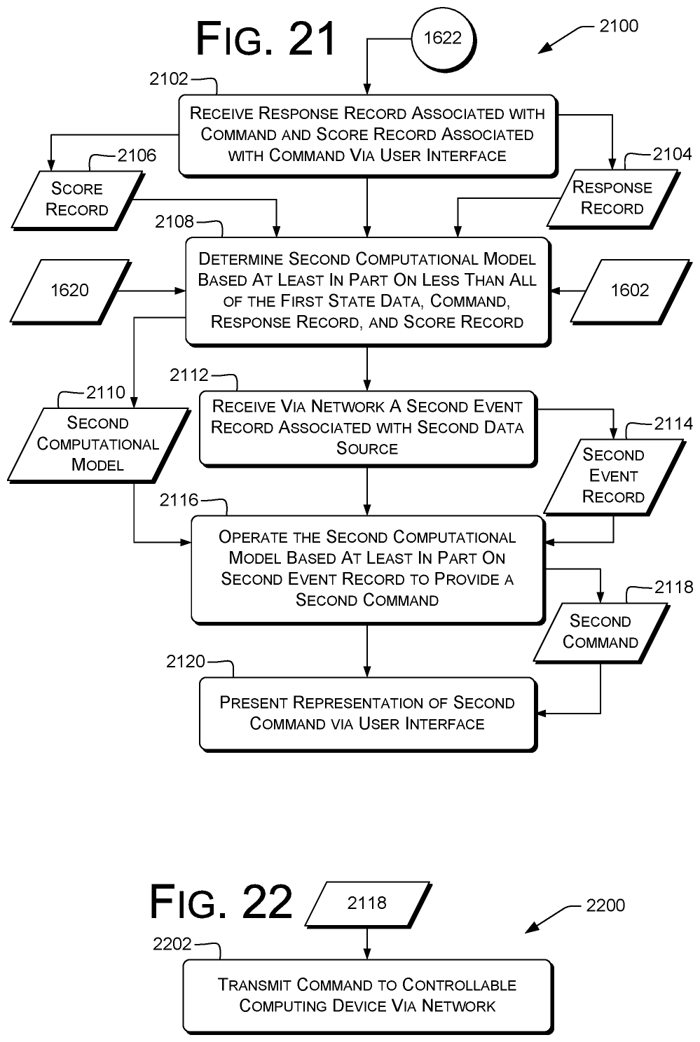

FIG. 22 is a dataflow diagram illustrating an example method 2200 for controlling a computing device and related data items. Method 2200 can be performed, e.g., by a monitoring device 810 such as that shown in FIG. 8, which can include control unit(s) configured to perform operations described below. Examples of control unit(s) are discussed herein with reference to FIG. 7.

At 2202, the control unit can transmit, via the network, the command 1620 to the controllable computing device 808 to cause the controllable computing device 808 to perform an action associated with the command 1620. Examples are discussed herein, e.g., with reference to operation 912, 1702.

FIG. 23 is a dataflow diagram illustrating an example method 2300 for controlling a computing device and related data items. Method 2300 can be performed, e.g., by a monitoring device 810 such as that shown in FIG. 8, which can include control unit(s) configured to perform operations described below. Examples of control unit(s) are discussed herein with reference to FIG. 7.

At 2302, the control unit can determine second state data 2304 based at least in part on the event record 1616. In various embodiments, 2302 occurs in response to the control unit determining that the event record 1616 is associated with a state change. Examples are discussed herein, e.g., with reference to operation 1002.

At 2306, the control unit can add the second state data 2304 to the state database. Examples are discussed herein, e.g., with reference to operation 1006.

At 2308, the control unit can record an indication 2310 of the adding of the second state data 2304 in a changelog data store. Examples are discussed herein, e.g., with reference to operation 1008.

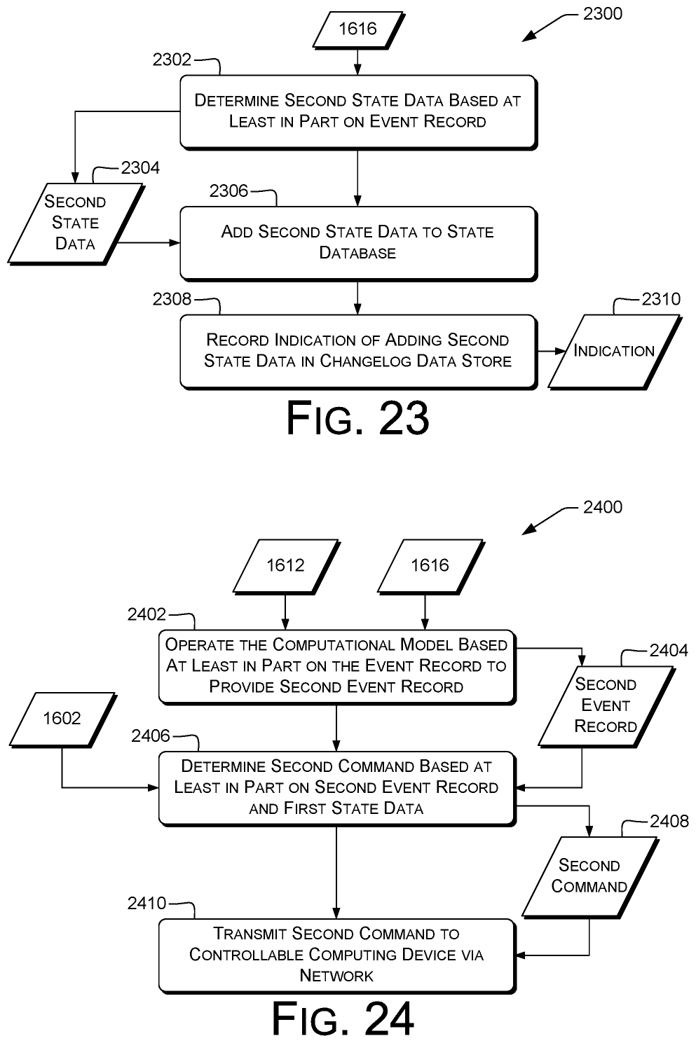

FIG. 24 is a dataflow diagram illustrating an example method 2400 for controlling a computing device and related data items. Method 2400 can be performed, e.g., by a monitoring device 810 such as that shown in FIG. 8, which can include control unit(s) configured to perform operations described below. Examples of control unit(s) are discussed herein with reference to FIG. 7.

At 2402, the control unit can operate the computational model 1612 based at least in part on the event record 1616 to provide a second event record 2404. Examples of operating computational models are discussed herein, e.g., with reference to operations 1410, 1618, 2116. In various embodiments, the computational model 1612 can be a machine-learning model that outputs a new event based on crowdsourced data.

At 2406, the control unit can determine, based at least in part on the first state data 1602 (which can be associated with, e.g., a first user or organization) and the second event record 2404 (which can be associated with, e.g., a second user or organization, by virtue of the association of the event record 1616 with the second user), a second command 2408. Examples are discussed herein, e.g., with reference to operations 908, 1210, 1410, 1618. For example, operations 2402, 2406 can permit combining data related to two different data sources to determine the command.

At 2410, the control unit can transmit, via a network, the second command 2408 to the controllable computing device 808 to cause the controllable computing device 808 to perform an action associated with the second command 2408. Examples are discussed herein, e.g., with reference to operations 912, 1102, 1214, 1502, 1622, 1702, 2006, 2202

### Example Clauses

Various examples include one or more of, including any combination of any number of, the following example features. Throughout these clauses, parenthetical remarks are for example and explanation, and are not limiting. Parenthetical remarks given in this Example Clauses section with respect to specific language apply to corresponding language throughout this section, unless otherwise indicated.

A: A system, comprising: an event-source device; a state database holding first state data; a controllable computing device; and a monitoring device communicatively connectable with the state database and, via at least one network, with the event-source device and the controllable device; wherein the monitoring device is configured to: receive an event record from the event-source device; determine, based at least in part on the first state data and the event record, a command; and transmit, via the at least one network, the command to the controllable computing device to cause the controllable computing device to perform an action associated with the command.

B: The system according to paragraph A, wherein: the system further comprises a user interface; the monitoring device is communicatively connectable, via the at least one network, with the user interface; and the monitoring device is configured to, in response to the receiving the event record, cause the user interface to present a representation at least a portion of the event record.

C: The system according to paragraph A or B, wherein the monitoring device is further configured to: determine second state data based at least in part on the event record; and add the second state data to the state database.

D: The system according to paragraph C, wherein the monitoring device is further configured to record an indication of the adding of the second state data in a changelog data store.

E: The system according to any of paragraphs A-D, wherein the command comprises at least one of: creation of a user account; deletion of a user account; modification of the access privileges of a user account; modification of firewall rules; modification of routing rules; enabling of a device; disabling of a device; enabling of a device driver; disabling of a device driver; enabling of a port; disabling of a port; installation of an update; presentation by a user interface of a toast, request to login, or another notification; presentation by a user interface of a prompt for yes/no or agree/disagree input, or other selection from a fixed list of choices; presentation by a user interface of a prompt for textual input; downloading of document file or other file; or requesting authorization for a change to the state database.

F: At least one tangible, non-transitory computer-readable medium comprising instructions executable by at least one processor to cause the at least one processor to perform operations comprising: receiving an event record from an event-source device via a network; retrieving first state data from a state database; determining, based at least in part on the first state data and the event record, a command; and cause a controllable computing device to carry out the command.

G: The at least one tangible, non-transitory computer-readable medium according to paragraph F, the operations further comprising: determining second state data based at least in part on the event record; and adding the second state data to the state database.

H: The at least one tangible, non-transitory computer-readable medium according to paragraph F or G, the operations further comprising: determining a computational model based at least in part on stored training event records and respective training response records; and determining the command by operating the computational model.

I: The at least one tangible, non-transitory computer-readable medium according to any of paragraphs F-H, the operations further comprising: presenting a representation of at least a portion of the command via a user interface; receiving, via the user interface, a response record associated with the command and a score record associated with the command; and determining a second computational model based at least in part on the command, the response record, and the score record.

J: A method, comprising: storing first state data in a state database, the first state data associated with a first data source; storing second state data in the state database, the second state data associated with a second, different data source; determining a computational model based at least in part on the first state data; receiving an event record associated with the second data source; operating the computational model based at least in part on the event record to provide a command; and presenting, via a user interface, a representation of the command.

K: The method according to paragraph J, further comprising transmitting the command to a controllable computing device to change operation of the controllable computing device.

L: The method according to paragraph J or K, further comprising: transmitting, via a network to the user interface, a prompt; and receiving the event record from the user interface after transmitting the prompt, the user interface associated with the second data source.

M: The method according to any of paragraphs J-L, further comprising determining the computational model at least partly by: determining, based at least in part on the first state data, one or more training event records and respective training response records, wherein at least one of the training response records indicates an action of a plurality of actions; receiving one or more training score records associated with respective training event records of the one or more training event records; and mathematically optimizing at least one parameter with respect to a cost function based at least in part on the training event records, the training response records, and the training score records to determine the computational model, wherein: the computational model is configured to receive as input at least a portion of the event record; and the computational model is configured to provide as output the command indicating an action of the plurality of actions.

N: The method according to paragraph M, further comprising: operating the computational model based at least in part on at least some of the second state data to provide an event prediction; and presenting, via the user interface, a representation of the event prediction.

O: The method according to any of paragraphs J-N, further comprising, after presenting the representation of the command: receiving, via the user interface, a response record associated with the command and a score record associated with the command; determining a second computational model based at least in part on less than all of the first state data, the command, the response record, and the score record; receiving, via a network, a second event record associated with the second data source; operating the second computational model based at least in part on the second event record to provide a second command; and presenting, via the user interface, a representation of the second command.

P: The method according to any of paragraphs J-O, further comprising transmitting, via the network, the command to a controllable computing device to cause the controllable computing device to perform an action associated with the command.

Q: The method according to any of paragraphs J-P, further comprising: determining second state data based at least in part on the event record; and adding the second state data to the state database.

R: The method according to paragraph Q, further comprising recording an indication of the adding of the second state data in a changelog data store.

S: The method according to any of paragraphs J-R, wherein the command comprises at least one of: creation of a user account; deletion of a user account; modification of the access privileges of a user account; modification of firewall rules; modification of routing rules; enabling of a device; disabling of a device; enabling of a device driver; disabling of a device driver; enabling of a port; disabling of a port; installation of an update; presentation by a user interface of a toast, request to login, or another notification; presentation by a user interface of a prompt for yes/no or agree/disagree input, or other selection from a fixed list of choices; presentation by a user interface of a prompt for textual input; downloading of document file or other file; or requesting authorization for a change to the state database.

T: The method according to any of paragraphs J-S, further comprising: operating the computational model based at least in part on the event record to provide a second event record; determining, based at least in part on the first state data and the second event record, a second command; and transmitting, via a network, the second command to a controllable computing device to cause the controllable computing device to perform an action associated with the second command.

U: A method, comprising: receiving an event record from an event-source device; determining, based at least in part on the first state data and the event record, a command; and transmitting, via at least one network, the command to a controllable computing device to cause the controllable computing device to perform an action associated with the command.

V: The method according to paragraph U, further comprising, in response to the receiving the event record, causing a user interface to present a representation at least a portion of the event record.

W: The method according to paragraph U or V, further comprising: determining second state data based at least in part on the event record; and adding the second state data to the state database.

X: The method according to paragraph W, further comprising recording an indication of the adding of the second state data in a changelog data store.

Y: The method according to any of paragraphs U-X, wherein the command comprises at least one of: creation of a user account; deletion of a user account; modification of the access privileges of a user account; modification of firewall rules; modification of routing rules; enabling of a device; disabling of a device; enabling of a device driver; disabling of a device driver; enabling of a port; disabling of a port; installation of an update; presentation by a user interface of a toast, request to login, or another notification; presentation by a user interface of a prompt for yes/no or agree/disagree input, or other selection from a fixed list of choices; presentation by a user interface of a prompt for textual input; downloading of document file or other file; or requesting authorization for a change to the state database.

Z: A system, comprising: a state database holding first state data; a controllable computing device; and a monitoring device communicatively connectable with the state database and, via at least one network, with the controllable computing device; wherein the monitoring device is configured to: receive an event record from the controllable computing device; determine, based at least in part on the first state data and the event record, a command; and transmit, via the at least one network, the command to the controllable computing device to cause the controllable computing device to perform an action associated with the command.

AA: The system according to paragraph Z, wherein: the system further comprises a user interface; the monitoring device is communicatively connectable, via the at least one network, with the user interface; and the monitoring device is configured to, in response to the receiving the event record, cause the user interface to present a representation at least a portion of the event record.

AB: The system according to paragraph Z or AA, wherein the monitoring device is further configured to: determine second state data based at least in part on the event record; and add the second state data to the state database.

AC: The system according to paragraph AB, wherein the monitoring device is further configured to record an indication of the adding of the second state data in a changelog data store.

AD: The system according to any of paragraphs Z-AC, wherein the command comprises at least one of: creation of a user account; deletion of a user account; modification of the access privileges of a user account; modification of firewall rules; modification of routing rules; enabling of a device; disabling of a device; enabling of a device driver; disabling of a device driver; enabling of a port; disabling of a port; installation of an update; presentation by a user interface of a toast, request to login, or another notification; presentation by a user interface of a prompt for yes/no or agree/disagree input, or other selection from a fixed list of choices; presentation by a user interface of a prompt for textual input; downloading of document file or other file; or requesting authorization for a change to the state database.

AE: A monitoring device communicatively connectable with a state database and, via at least one network, with an event-source device and a controllable device; wherein the monitoring device is configured to: receive an event record from the event-source device; determine, based at least in part on the first state data and the event record, a command; and transmit, via the at least one network, the command to the controllable computing device to cause the controllable computing device to perform an action associated with the command.

AF: The monitoring device according to paragraph AE, wherein: the monitoring device is communicatively connectable, via at least one network, with the user interface; and the monitoring device is configured to, in response to the receiving the event record, cause the user interface to present a representation at least a portion of the event record.

AG: The monitoring device according to paragraph AE or AF, wherein the monitoring device is further configured to: determine second state data based at least in part on the event record; and add the second state data to the state database.

AH: The monitoring device according to paragraph AG, wherein the monitoring device is further configured to record an indication of the adding of the second state data in a changelog data store.

AI: The monitoring device according to any of paragraphs AE-AH, wherein the command comprises at least one of: creation of a user account; deletion of a user account; modification of the access privileges of a user account; modification of firewall rules; modification of routing rules; enabling of a device; disabling of a device; enabling of a device driver; disabling of a device driver; enabling of a port; disabling of a port; installation of an update; presentation by a user interface of a toast, request to login, or another notification; presentation by a user interface of a prompt for yes/no or agree/disagree input, or other selection from a fixed list of choices; presentation by a user interface of a prompt for textual input; downloading of document file or other file; or requesting authorization for a change to the state database.

AJ: A system, comprising: an event-source device; a state database holding first state data; a controllable computing device; and a monitoring device communicatively connectable with the state database and, via at least one network, with the event-source device and the controllable device; wherein the monitoring device is configured to: receive an event record from the event-source device; determine, based at least in part on the first state data and the event record, a configuration command; and transmit, via the at least one network, the configuration command to the controllable computing device to cause a configuration change at the controllable computing device.

AK: The system according to paragraph AJ, wherein: the system further comprises a user interface; the monitoring device is communicatively connectable, via the at least one network, with the user-interface device; and the monitoring device is configured to, in response to the receiving the event record, cause the user interface to present a representation at least a portion of the event record.

AL: The system according to paragraph AJ or AK, wherein the monitoring device is further configured to, in response to the determining that the event record is associated with a state change: determine second state data based at least in part on the event record; and replace at least some of the first state data in the state database with the second state data.

AM: The system according to paragraph AL, wherein the monitoring device is further configured to record an indication of the replacing of the at least some of the first state data in a changelog data store.

AN: The system according to any of paragraphs AJ-AM, wherein the configuration change comprises at least one of: creation of a user account; deletion of a user account; modification of the access privileges of a user account; modification of firewall rules; modification of routing rules; enabling of a device; disabling of a device; enabling of a device driver; disabling of a device driver; enabling of a port; disabling of a port; or installation of an update.

AO: At least one tangible, non-transitory computer-readable medium comprising instructions executable by at least one processor to cause the at least one processor to perform operations comprising: receiving an event record from a controllable computing device via a network; retrieving first state data from a state database; determining, based at least in part on the first state data and the event record, a command; and transmitting, via the at least one network, the command to the controllable computing device to change operation of the controllable computing device.

AP: The at least one tangible, non-transitory computer-readable medium according to paragraph AO, the operations further comprising, in response to the determining that the event record is associated with a state change: determining second state data based at least in part on the event record; and replacing at least some of the first state data in the state database with the second state data.

AQ: The at least one tangible, non-transitory computer-readable medium according to paragraph AO or AP, the operations further comprising: determining a computational model based at least in part on stored training event records and respective training response records; and determining the command by operating the computational model.

AR: The at least one tangible, non-transitory computer-readable medium according to paragraph AQ, the operations further comprising: presenting a representation at least a portion of the command via a user interface; receiving, via the user interface, a response record associated with the command and a score record associated with the command; and determining a second computational model based at least in part on the command, the response record, and the score record.

AS: A method, comprising: storing first state data in a state database, the first state data associated with a first data source; storing second state data in the state database, the second state data associated with a second, different data source; determining a computational model based at least in part on the first state data; receiving, via a network, an event record associated with the second data source; operating the computational model based at least in part on the event record to provide a command record; and presenting, via a user interface, a representation of the command record.

AT: The method according to paragraph AS, further comprising transmitting the command record to a controllable computing device to change operation of the controllable computing device.

AU: The method according to paragraph AS or AT, further comprising: transmitting, via the network to the user interface, a prompt; and receiving the event record from the user interface in response to the prompt, the user interface associated with the second data source.

AV: The method according to any of paragraphs AS-AU, further comprising determining the computational model at least partly by: determining, based at least in part on the first state data, one or more training event records and respective training response records, wherein at least one of the training response records indicates an action of a plurality of actions; receiving one or more training score records associated with respective training event records of the one or more training event records; and mathematically optimizing at least one parameter with respect to a cost function based at least in part on the training event records, the training response records, and the training score records to determine the computational model, wherein: the computational model is configured to receive as input at least a portion of the event record; and the computational model is configured to provide as output the command record indicating a command action of the plurality of actions.

AW: The method according to paragraph AV, further comprising: operating the computational model based at least in part on at least some of the second state data to provide an event prediction; and presenting, via the user interface, a representation of the event prediction.

AX: The method according to any of paragraphs AS-AW, wherein the monitoring device is further configured to, after presenting the representation of the command record: receiving, via the user interface, a response record associated with the command record and a score record associated with the command record; determining a second computational model based at least in part on less than all of the first state data, the command record, the response record, and the score record; receiving, via a network, a second event record associated with the second data source; operating the second computational model based at least in part on the second event record to provide a second command record; and presenting, via the user interface, a representation of the second command record.

AY: A computer-readable medium, e.g., a computer storage medium, having thereon computer-executable instructions, the computer-executable instructions upon execution configuring a computer to perform operations as any of paragraphs A-E, F-I, J-T, U-Z, Z-AD, AE-AI, AJ-AN, AO-AR, or AS-AX recites.

AZ: A device comprising: a processor; and a computer-readable medium, e.g., a computer storage medium, having thereon computer-executable instructions, the computer-executable instructions upon execution by the processor configuring the device to perform operations as any of paragraphs A-E, F-I, J-T, U-Z, Z-AD, AE-AI, AJ-AN, AO-AR, or AS-AX recites.

BA: A system comprising: means for processing; and means for storing having thereon computer-executable instructions, the computer-executable instructions including means to configure the system to carry out a method as any of paragraphs A-E, F-I, J-T, U-Z, Z-AD, AE-AI, AJ-AN, AO-AR, or AS-AX recites.

BB: A method comprising performing operations as any of paragraphs A-E, F-I, J-T, U-Z, Z-AD, AE-AI, AJ-AN, AO-AR, or AS-AX recites.

Various examples include one or more of, including any combination of any number of, the following example features. Throughout these clauses, parenthetical remarks are for example and explanation, and are not limiting. Parenthetical remarks given in this Example Clauses section with respect to specific language apply to corresponding language throughout this section, unless otherwise indicated.

### Conclusion

This disclosure is inclusive of combinations of the aspects described herein. References to “a particular aspect” (or “embodiment” or “version”) and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting.

Although some features and examples herein have been described in language specific to structural features or methodological steps, it is to be understood that the subject matter herein is not necessarily limited to the specific features or steps described. For example, the operations of example processes herein are illustrated in individual blocks and logical flows thereof, and are summarized with reference to those blocks. The order in which the operations are described is not intended to be construed as a limitation unless otherwise indicated, and any number of the described operations can be executed in any order, combined in any order, subdivided into multiple sub-operations, or executed in parallel to implement the described processes. For example, in alternative implementations included within the scope of the examples described herein, elements or functions can be deleted, or executed out of order from that shown or discussed, including substantially synchronously or in reverse order.

Each illustrated block can represent one or more operations that can be implemented in hardware, software, or a combination thereof. In the context of software, the operations described herein represent computer-executable instructions stored on at least one computer-readable medium that, when executed by one or more processors, enable the one or more processors to perform the recited operations. Accordingly, the methods and processes described above can be embodied in, and fully automated via, software code modules executed by one or more computers or processors. Generally, computer-executable instructions include routines, programs, objects, modules, code segments, components, data structures, and the like that perform particular functions or implement particular abstract data types. Some or all of the methods can additionally or alternatively be embodied in specialized computer hardware. For example, various aspects herein may take the form of an entirely hardware aspect, an entirely software aspect (including firmware, resident software, micro-code, etc.), or an aspect combining software and hardware aspects. These aspects can all generally be referred to herein as a “service,” “circuit,” “circuitry,” “module,” or “system.” The described processes can be performed by resources associated with one or more data-processing systems 700, 718 or processors 702, such as one or more internal or external CPUs or GPUs, or one or more pieces of hardware logic such as FPGAs, DSPs, or other types of accelerators.

Conditional language such as, among others, “can,” “could,” “might” or “may,” unless specifically stated otherwise, are understood within the context to present that certain examples include, while other examples do not include, certain features, elements or steps. Thus, such conditional language is not generally intended to imply that certain features, elements or steps are in any way required for one or more examples or that one or more examples necessarily include logic for deciding, with or without user input or prompting, whether certain features, elements or steps are included or are to be performed in any particular example.

The word “or” and the phrase “and/or” are used herein in an inclusive sense unless specifically stated otherwise. Accordingly, conjunctive language such as, but not limited to, at least one of the phrases “X, Y, or Z,” “at least X, Y, or Z,” “at least one of X, Y or Z,” and/or any of those phrases with “and/or” substituted for “or,” unless specifically stated otherwise, is to be understood as signifying that an item, term, etc., can be either X, Y, or Z, or a combination of any elements thereof (e.g., a combination of XY, XZ, YZ, and/or XYZ). Any use herein of phrases such as “X, or Y, or both” or “X, or Y, or combinations thereof” is for clarity of explanation and does not imply that language such as “X or Y” excludes the possibility of both X and Y, unless such exclusion is expressly stated. As used herein, language such as “one or more Xs” shall be considered synonymous with “at least one X” unless otherwise expressly specified. Any recitation of “one or more Xs” signifies that the described steps, operations, structures, or other features may, e.g., include, or be performed with respect to, exactly one X, or a plurality of Xs, in various examples, and that the described subject matter operates regardless of the number of Xs present.

It should be emphasized that many variations and modifications can be made to the above-described examples, the elements of which are to be understood as being among other acceptable examples. All such modifications and variations are intended to be included herein within the scope of this disclosure and protected by the following claims. Moreover, in the claims, any reference to a group of items provided by a preceding claim clause is a reference to at least some of the items in the group of items, unless specifically stated otherwise. This document expressly envisions alternatives with respect to each and every one of the following claims individually, in any of which claims any such reference refers to each and every one of the items in the corresponding group of items. Furthermore, in the claims, unless otherwise explicitly specified, an operation described as being “based on” a recited item can be performed based on only that item or based at least in part on that item. This document expressly envisions alternatives with respect to each and every one of the following claims individually, in any of which claims any “based on” language refers to the recited item(s), and no other(s). Additionally, in any claim using the “comprising” transitional phrase, recitation of a specific number of components (e.g., “two Xs”) is not limited to embodiments including exactly that number of those components, unless expressly specified (e.g., “exactly two Xs”). However, such a claim does describe both embodiments that include exactly the specified number of those components and embodiments that include at least the specified number of those components.

What is claimed is:

1. A system, comprising:
an event-source device;
a state database holding first state data;
a controllable computing device; and
a monitoring device communicatively connectable with the state database and, via at least one network, with the event-source device and the controllable device;
wherein the monitoring device is configured to:
receive an event record from the event-source device;
determine, based at least in part on the first state data and the event record, a command; and
transmit, via the at least one network, the command to the controllable computing device to cause the controllable computing device to perform an action associated with the command.

2. The system according to claim 1, wherein:
the system further comprises a user interface;
the monitoring device is communicatively connectable, via the at least one network, with the user interface; and
the monitoring device is configured to, in response to the receiving the event record, cause the user interface to present a representation at least a portion of the event record.

3. The system according to claim 1, wherein the monitoring device is further configured to:
determine second state data based at least in part on the event record; and
add the second state data to the state database.

4. The system according to claim 3, wherein the monitoring device is further configured to record an indication of the adding of the second state data in a changelog data store.

5. The system according to claim 1, wherein the command comprises at least one of: creation of a user account; deletion of a user account; modification of the access privileges of a user account; modification of firewall rules; modification of routing rules; enabling of a device; disabling of a device; enabling of a device driver; disabling of a device driver; enabling of a port; disabling of a port; installation of an update; presentation by a user interface of a toast, request to login, or another notification; presentation by a user interface of a prompt for yes/no or agree/disagree input, or other selection from a fixed list of choices; presentation by a user interface of a prompt for textual input; downloading of document file or other file; or requesting authorization for a change to the state database.

6. At least one tangible, non-transitory computer-readable medium comprising instructions executable by at least one processor to cause the at least one processor to perform operations comprising:
receiving an event record from an event-source device via a network;
retrieving first state data from a state database;
determining, based at least in part on the first state data and the event record, a command; and
cause a controllable computing device to carry out the command.

7. The at least one tangible, non-transitory computer-readable medium according to claim 6, the operations further comprising:
determining second state data based at least in part on the event record; and
adding the second state data to the state database.

8. The at least one tangible, non-transitory computer-readable medium according to claim 6, the operations further comprising:
determining a computational model based at least in part on stored training event records and respective training response records; and
determining the command by operating the computational model.

9. The at least one tangible, non-transitory computer-readable medium according to claim 6, the operations further comprising:
presenting a representation of at least a portion of the command via a user interface;
receiving, via the user interface, a response record associated with the command and a score record associated with the command; and
determining a second computational model based at least in part on the command, the response record, and the score record.

10. A method, comprising:
storing first state data in a state database, the first state data associated with a first data source;
storing second state data in the state database, the second state data associated with a second, different data source;
determining a computational model based at least in part on the first state data;
receiving an event record associated with the second data source;
operating the computational model based at least in part on the event record to provide a command; and
presenting, via a user interface, a representation of the command.

11. The method according to claim 10, further comprising transmitting the command to a controllable computing device to change operation of the controllable computing device.

12. The method according to claim 10, further comprising:
transmitting, via a network to the user interface, a prompt; and
receiving the event record from the user interface after transmitting the prompt, the user interface associated with the second data source.

13. The method according to claim 10, further comprising determining the computational model at least partly by:
determining, based at least in part on the first state data, one or more training event records and respective training response records, wherein at least one of the training response records indicates an action of a plurality of actions;
receiving one or more training score records associated with respective training event records of the one or more training event records; and
mathematically optimizing at least one parameter with respect to a cost function based at least in part on the training event records, the training response records, and the training score records to determine the computational model, wherein:
the computational model is configured to receive as input at least a portion of the event record; and
the computational model is configured to provide as output the command indicating an action of the plurality of actions.

14. The method according to claim 13, further comprising:
operating the computational model based at least in part on at least some of the second state data to provide an event prediction; and
presenting, via the user interface, a representation of the event prediction.

15. The method according to claim 10, further comprising, after presenting the representation of the command:
receiving, via the user interface, a response record associated with the command and a score record associated with the command;
determining a second computational model based at least in part on less than all of the first state data, the command, the response record, and the score record;
receiving, via a network, a second event record associated with the second data source;
operating the second computational model based at least in part on the second event record to provide a second command; and
presenting, via the user interface, a representation of the second command.

16. The method according to claim 10, further comprising transmitting, via the network, the command to a controllable computing device to cause the controllable computing device to perform an action associated with the command.

17. The method according to claim 10, further comprising:
determining second state data based at least in part on the event record; and
adding the second state data to the state database.

18. The method according to claim 17, further comprising recording an indication of the adding of the second state data in a changelog data store.

19. The method according to claim 10, wherein the command comprises at least one of: creation of a user account; deletion of a user account; modification of the access privileges of a user account; modification of firewall rules; modification of routing rules; enabling of a device; disabling of a device; enabling of a device driver; disabling of a device driver; enabling of a port; disabling of a port; installation of an update; presentation by a user interface of a toast, request to login, or another notification; presentation by a user interface of a prompt for yes/no or agree/disagree input, or other selection from a fixed list of choices; presentation by a user interface of a prompt for textual input; downloading of document file or other file; or requesting authorization for a change to the state database.

20. The method according to claim 10, further comprising:
operating the computational model based at least in part on the event record to provide a second event record;
determining, based at least in part on the first state data and the second event record, a second command; and
transmitting, via a network, the second command to a controllable computing device to cause the controllable computing device to perform an action associated with the second command.
